(19) United States
(12) Patent Application Publication
(10) Pub. No.: US 2018/0356492 A1
(43) Pub. Date: Dec. 13, 2018

(54) VISION BASED LOCATION ESTIMATION SYSTEM

(71) Applicant: Michael Hamilton, Lewisville, TX (US)

(72) Inventor: Michael Hamilton, Lewisville, TX (US)

(21) Appl. No.: 16/108,331

(22) Filed: Aug. 22, 2018

Related U.S. Application Data
(63) Continuation-in-part of application No. 15/804,289, filed on Nov. 6, 2017, now Pat. No. 10,094,910.
Application No. 15/804,289 is a continuation of application No. 15/183,745, filed on Jun. 15, 2016, now Pat. No. 9,810,767.
(60) Provisional application No. 62/549,301, filed on Aug. 23, 2017.
(60) Provisional application No. 62/296,109, filed on Feb. 17, 2016.
(60) Provisional application No. 62/180,596, filed on Jun. 16, 2015.

(51) Int. Cl. G01S 5/14; G01S 13/76; G01S 13/87; G01S 5/02; H04W 4/02

(52) U.S. Cl. CPC G01S 5/14; G01S 13/76; G01S 13/878; G01S 5/0263; H04W 4/027; G01S 5/0257; G01S 5/0242

(57) ABSTRACT

A location estimation system includes a plurality of Kalman filters, a UWB position system, a pressure sensor, a temperature sensor and a MEMs chip that provides gyroscope, accelerometer and magnetometer information. The data is Kalman filtered to determine precise location information that is more precise any sensor that is processed to determine the probable location of a device. The system further includes at least one camera based location determination systems is configured to provide either two dimensional or three-dimensional data wherein the system utilizes the absolute location information as well as the camera data to determine a precise location notwithstanding anomalies in the absolute location information. In one embodiment, the data from the location estimation system is fused with data from the camera based location determination system to generate data that, overall, is more accurate than data from either source.

### CROSS REFERENCE TO RELATED APPLICATIONS

The present U.S. Utility patent application claims priority pursuant to 35 U.S.C. § 119(e) to U.S. Provisional Application No. 62/549,301, entitled “CAMERA BASED LOCATION ESTIMATION SYSTEM”, filed Aug. 23, 2017, which is hereby incorporated herein by reference in its entirety and made part of the present U.S. Utility patent application for all purposes.

The present U.S. Utility patent application also claims priority pursuant to 35 U.S.C. § 120 as a continuation-in-part of U.S. Utility application Ser. No. 15/804,289, entitled “LOCATION ESTIMATION SYSTEM”, filed Nov. 6, 2017, which is a continuation of U.S. Utility patent application Ser. No. 15/183,745, entitled “LOCATION ESTIMATION SYSTEM”, filed Jun. 15, 2016, now U.S. Pat. No. 9,810,767, issued Nov. 7, 2017, which claims priority pursuant to 35 U.S.C. § 119(e) to U.S. Provisional Application No. 62/296,109, entitled “LOCATION ESTIMATION SYSTEM”, filed Feb. 17, 2016, and to U.S. Provisional Application No. 62/180,596, entitled “LOCATION ESTIMATION SYSTEM”, filed Jun. 16, 2015, all of which are hereby incorporated herein by reference in their entirety and made part of the present U.S. Utility patent application for all purposes.

### BACKGROUND

### 1. Technical Field

The present invention relates to location estimation systems and, more specifically, to camera based location estimation systems.

### 2. Related Art

New types of location estimation devices are needed with the development of Virtual Reality, Augmented Reality, Autonomous Drones and Self Driving Cars, there is a need for precise location determination. Recently, GPS systems have become more accurate after military level precision was made accessible to the public. GPS based systems, however, don't work indoors and other locations such as under bridges or other structures that block a signal path in the direction of the GPS satellites. These new types of applications require location estimation devices to operate at high speeds with update rates of 60-150 times per second and often require sub millimeter precision levels. It has been found that vision based systems can temporarily meet some of these application needs but cannot meet such needs for accuracy on a sustained basis. The most successful algorithms have been based on either VO (visual odometry) or vision based SLAM (simultaneous location and mapping). VO has been used successfully with drones for stabilization during flight. Both VO and SLAM based systems, however, have a cumulative drift problem, but the SLAM systems have done a much better job at solving the localization problem. Nonetheless, a system, device and method is needed that improves the operation of location estimation.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

A better understanding of the present invention can be obtained when the following detailed description of the preferred embodiment is considered with the following drawings, in which:

FIG. 1 is a block diagram that illustrates a location determination system according to one embodiment.

FIG. 2 is a block diagram that illustrates an ultra-wideband position determination system.

FIG. 3 is a block diagram that illustrates an ultra-wideband position determination system.

FIG. 4 is a table that illustrates a channel configuration chart according to a communication standard utilized in one embodiment.

FIG. 5 is a block diagram that illustrates TOA (time of arrival) algorithm according to one embodiment.

FIG. 6 is a block diagram that illustrates operation of an automatic anchor location determination algorithm by a plurality of anchors according to one embodiment.

FIG. 7 is a block diagram that illustrates operation of a trilateration algorithm by a plurality of anchors according to one embodiment.

FIG. 8 is a block diagram that illustrates operation of an altitude algorithm according to one embodiment.

FIG. 9 is a functional block diagram that illustrates a location determination processing block that includes a plurality of Kalman filters according to one embodiment that utilizes the various values derived by circuitry as described above.

FIG. 10 is a diagram used to illustrate a 3 Dimensional (3D) Auto Anchor Location Algorithm according to one embodiment.

FIG. 11 is a block diagram that illustrates a method for a 3D Trilateration Algorithm.

FIG. 12 is a diagram used to illustrate a 3 Dimensional (3D) Trilateration Algorithm according to one embodiment.

FIG. 13 is a functional block diagram of a system according to one embodiment that illustrates operation.

FIG. 14 illustrates a method for estimating a location according to one embodiment of the invention.

FIG. 15 is a flow chart that illustrates a method for determining a tag/processor device location according to one embodiment.

FIG. 16 is a functional block diagram of a tag/processor device according to one embodiment.

FIG. 17 is a functional block diagram of an anchor in a location determination system that comprises a plurality of anchors and a tag/processor device according to one embodiment.

FIG. 18 is a functional block diagram of a computer readable media containing computer instructions that defines operational logic for a processor of a location determination tag/processor according to one embodiment.

FIG. 19 is a functional block diagram of a high speed artificial intelligence tracking (HSAIT™) system that further includes a vision system for tracking movement according to one embodiment.

FIG. 20 is a functional block diagram of an HSAIT™ system according to one embodiment.

FIG. 21 is a functional block diagram that illustrates additional details of how an HSKT™ system is combined with an HSAIT™ system to provide precise location information.

FIG. 22 is a functional block diagram of a HSVT™ system according to one embodiment.

FIG. 23 is a functional block diagram that illustrates functional operation of the HSKT™ tag/processor and the vision tracking system according to one embodiment of the disclosure.

FIG. 24 is a functional block diagram of a vision system according to one embodiment of the disclosure.

FIG. 25 is a functional block diagram that illustrates one aspect of operation of an HSVT™ system according to one embodiment of the disclosure.

FIG. 26 is a table that illustrates use of a dynamic mixing constant (MIX_POS_n) based on operational conditions.

FIG. 27 is a functional block diagram of a vision system according to one embodiment of the invention.

FIG. 28 is a functional block diagram of a vision based location tracking system according to one embodiment.

FIG. 29 is a functional block diagram of a high speed vision tracking system that fuses relative location information with absolute location information according to one embodiment.

FIG. 30 is a flow chart illustrating one embodiment of the present disclosure performed by a location determination system that is part of an automobile.

FIG. 31 is a flow chart illustrating a method of a robotic device that includes a location determination system according to one embodiment of the disclosure.

### DETAILED DESCRIPTION OF THE DRAWINGS

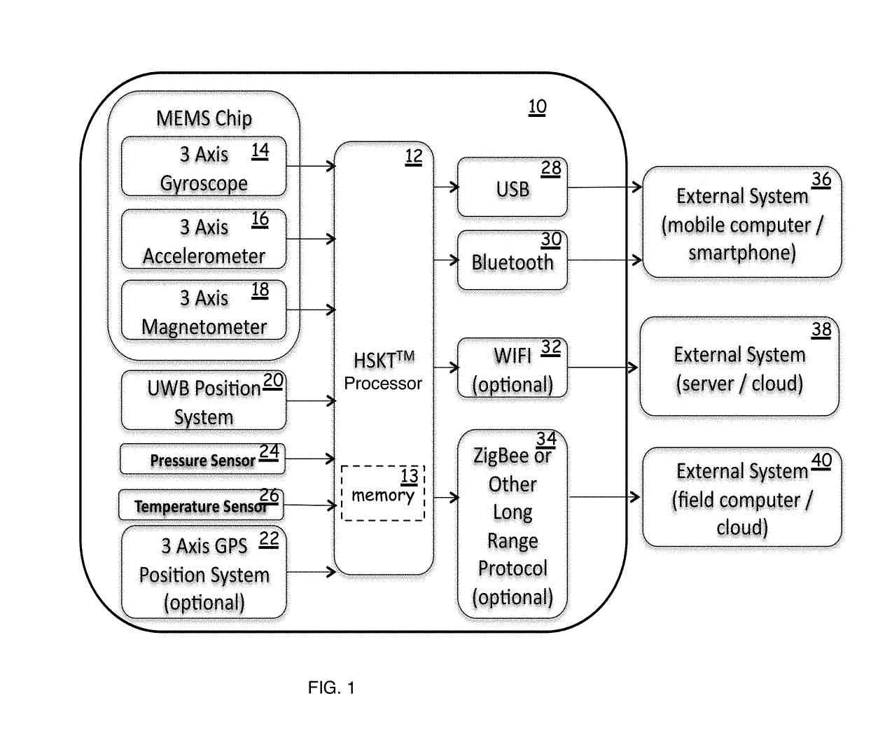

FIG. 1 is a block diagram that illustrates a location determination system according to one embodiment. More specifically, FIG. 1 illustrates one embodiment of a high speed Kalman tracking (HSKT™) location determination device 10 that includes a plurality of sensor types whose data is processed by a processor 12 to determine location with a high degree of accurate resolution. Location determination device 10 is referenced herein as a tag/processor device 10. Processor 12 is a general purpose or application specific processor configured to operate as a high speed Kalman tracking device that Kalman filters received data from a plurality of sensors to determine precise location information. A memory 13 is coupled to deliver computer instructions to processor 12 for execution. The computer instructions are configured to cause processor 12 to perform the described functionality including the Kalman filtering of the sensor data to determine precise location information.

The data sensors include a 3-axis gyroscope 14, a 3-axis accelerometer 16 and a 3-axis magnetometer 18. The data from these sensors 14, 16 and 18 are processed by processor 12 along with data from an ultra-wide band position system 20, an optional a 3-axis global positioning system (GPS) 22, a pressure sensor 24, and a temperature sensor 26. In at least one embodiment, processor 12 is operable to generate three dimensional location information that is accurate within 1 cm in one embodiment, though no one piece of information from the sensors/systems 14-26 provide data with that level of precision. Processor 12, shown as HSKT™, combines the data with multiple Kalman filters at high speed (200 Hz or higher) to give a precise (+−1 mm or better) three-dimensional location estimate in yet another embodiment. In either embodiment, one aspect of device 10 is that the final location information is far more precise that the accuracy of any of the sensors that are coupled to deliver sensor data to processor 12 for Kalman filtering and processing.

Processor 12 includes or is coupled to a memory that includes computer instructions that define the operational steps of processor 12. More specifically, the memory includes computer instructions that, when executed by processor 12 cause processor 12 to operate as described herein including, for example, the Kalman filtering, etc., and more generally, to perform the necessary steps described herein to perform the precise location determination functionality described herein. Once the location estimate is calculated, the values are transmitted out of the system to an external device, if desired, using one of USB 28, Bluetooth 30, Wi-Fi 32 (I.E.E.E. 802.11 (a-n), 802.15, ZigBee 34, or other communication technologies such as cellular communications.

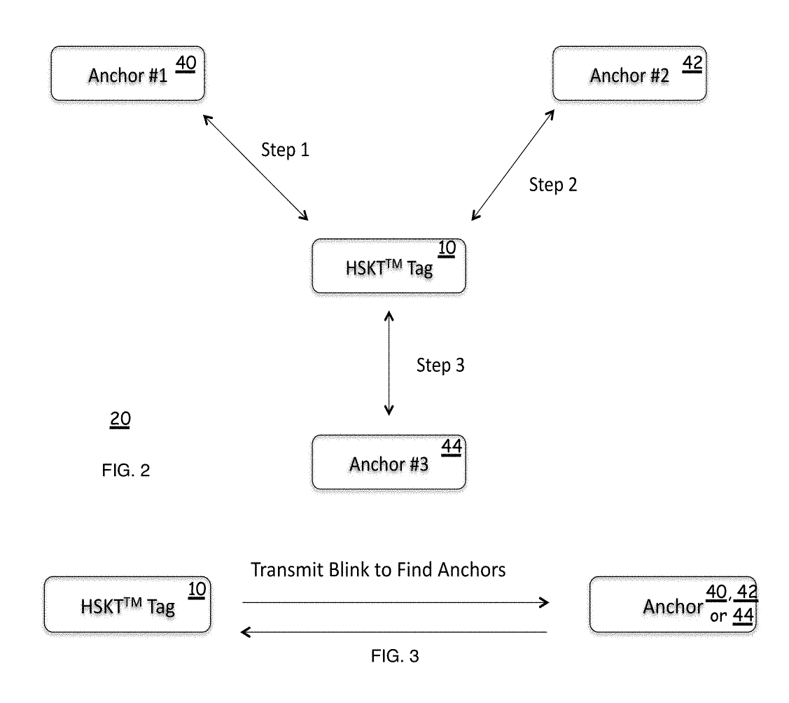

FIG. 2 is a block diagram that illustrates an ultra-wideband position determination system in relation to a location determination device. An UWB (ultra-wideband) position determination system 20 is configured to enable tag/processor device 10 to determine a precise location as fast as possible. A minimum of 3 anchors 40, 42 and 44 within range of the tag/processor device 10 are required to enable processor 12 of tag/processor device 10 to obtain and determine accurate position information from the UWB system 20. An unlimited number of anchors can be used to improve signal strength and extend the range of the system. If there are more than 3 anchors within range of the tracked HSKT™ tag or processor 12 then the 3 anchors with the best signal quality are chosen for performing triangulation to ascertain a location of processor 12 according to an embodiment.

In each step, the tag/processor device 10 determines a time of arrival (TOA) using a TOA algorithm to determine the distance between the tag or processor 12 and each anchor 40-44. Steps 1-3 are executed one by one and then repeated. This process will be described in greater detail below.

Initially, either the anchor positions are manually measured or determined or a special auto anchor location algorithm is used. Then at each step shown above, a distance from the anchor to the tag is calculated. Once the first three steps are completed, then the trilateration algorithm is started. Then after each new step, the trilateration algorithm is repeated to get the new position. An ultra-wideband signal is used for communications between tag/processor device 10 and each of the anchors.

FIG. 3 is a block diagram that illustrates operation of an ultra-wideband position determination system according to one embodiment. As suggested above, an initial step includes pairing the tag or processor 12 with the three anchors that have the best signal quality (among other factors). To achieve this, processor 12 performs a discovery algorithm to identify all anchors that are present. Thereafter, depending on signal strength as well as relative angles of the anchors in relation to the tag or processor 12, processor 12 of tag/processor device 10 selects which three anchors will be used for subsequent triangulation processing. One reason the relative angles are considered is that if, for example, the three strongest signals were for three angles that are axially aligned while a fourth anchor is located angularly differentiated, using the fourth anchor in place of one of the first three anchors with the best signal strength may allow the processor to more readily or accurately determine its location.

Initially, the tag or processor 12 transmits a blink message on a specific channel and preamble code and then listens to see which anchors are within range of the tag. This blink message is similar to a beacon signal transmitted in some communication protocols. Here, the communication process follows the I.E.E.E. 802.15.4-2011 standard. Each anchor 40-44 has a unique serial number and is set to use a specific channel and preamble code. The tag or processor 10 cycles through the channels and four preamble codes per channel while transmitting each blink message. Once all channels and preamble codes have been tried, a table of available anchors and their signal quality is generated. The processor 12 of tag/processor 10 then selects the three anchors within range that have the best quality signal unless angular differentiation between the anchors may prompt processor 12 to select a different anchor. The tag/processor 10 will continue to communicate with the three selected anchors 40-44 unless the signal quality drops below a minimum threshold at which the discovery process will be repeated. Once three anchors are selected then the TOA (time of arrival) algorithm continues to determine the distance between tag/processor 10 and each of the selected anchors 40-44.

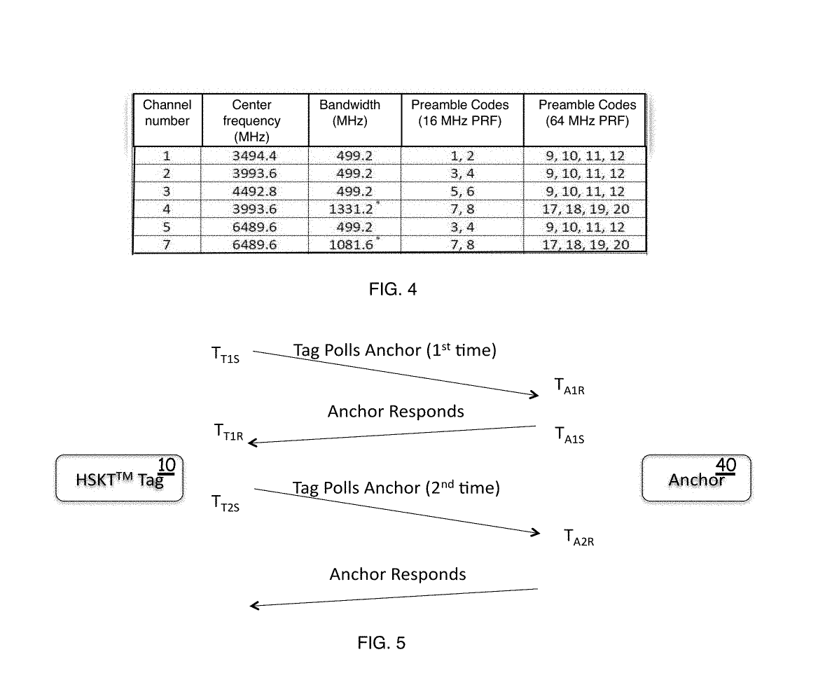

FIG. 4 is a table that illustrates a channel configuration chart according to a communication standard utilized in one embodiment. The UWB position system uses a radio in the described embodiment that operates according to the I.E.E.E. 802.15.4 (2011) standard. Each anchor will have its own unique serial number and be set to operate on a specific channel with a specific preamble code (at 64 MHz PRF). The tag/processor (e.g., tag/processor 10) switches between the 7 channels and 4 preamble codes shown in the table above to determine which anchors are within range. The tag/processor 10 then builds a table of anchor serial numbers versus signal quality to determine which 3 anchors communicate with to perform triangulation calculations.

FIG. 5 is a block diagram that illustrates a TOA (time of arrival) algorithm according to one embodiment. For the purpose of the example of FIG. 5, tag/processor 10 initially communicates with anchor 40.

A. Initially, the tag/processor 10 sets the preamble code and channel to select an anchor (here, anchor 40) from the three anchors 40-44 selected in the discovery step for a subsequent communication.

B. The tag/processor 10 stores the current timestamp (TT1S) and sends it to the anchor 40 in a 1^{st} poll message.

C. The anchor 40 receives the 1^{st} poll message notes current timestamp (TA1R), waits a fixed response time and then notes current timestamp (TA1S) and sends to the tag/processor 10. The tag/processor 10 notes the current timestamp (TT1R), waits a fixed response time and then notes the current timestamp (TT2S) and sends to anchor 40.

D. Anchor 40 notes current timestamp (TA2R), calculates TOF (time of flight) according to the equation shown in FIG. 5 and responds to tag/processor 10. The TOF measured is adjusted by a delay time from an antenna/device calibration table. This adjusts for any delay that can be attributed to a period from when the signal is received at the antenna and when it is processed by the processor 12 of tag/processor 10.

E. TOF is calculated as follows:

TRP1=T_{T1R}−T_{T1S} (1)

TRP2=T_{A2R}−T_{A1S} (2)

TDLY1=T_{A1S}−T_{A1R} (3)

TDLY2=T_{T2S}−T_{T1R} (4)

Accordingly,

TOF=(TRP1*TRP2−TDLY1*TDLY2)/(TRP1+TRP2+TDLY1+TDLY2) (5)

F. Once the tag/processor 10 has the 2nd response from anchor 40, processor 12 of tag/processor 10 calculates the distance according to the formula:

distance=TOF*speed of light. (6)

The raw distance is calculated here as the TOF*speed of light as shown in equation (6). The speed of light comes from a table for light being propagated through air at a current temperature and pressure reading. The temperature and pressure readings from the sensors may be used to select a speed of light value from a table that includes speed of light adjustments in air for temperature and pressure variations.

G. The calculated distance is used as an entry in a look up table to determine a calibration factor. The distance is recalculated according to the formula:

calibrated distance=calibration factor*distance (7)

wherein distance is the previously calculated distance and wherein table that adjusts for error that is present based on incident signal level at the antenna.

H. The distance is then saved for a specific anchor serial number.

I. Then tag/processor device 10 then changes the channel and preamble code to match the next anchor and repeats the process until a calibrated distance has been determined for each of the remaining selected anchors 40-44 that, here, are anchors 42-44.

The fixed response times (TA1S-TA1R) and (TT2S-TT1R) are kept as similar and as small as possible to reduce timing variation. An important point is that using these two round trips to eliminate the local clock values in the calculation serves to eliminate differences in the clocks and further avoids the need to synchronize the clocks.

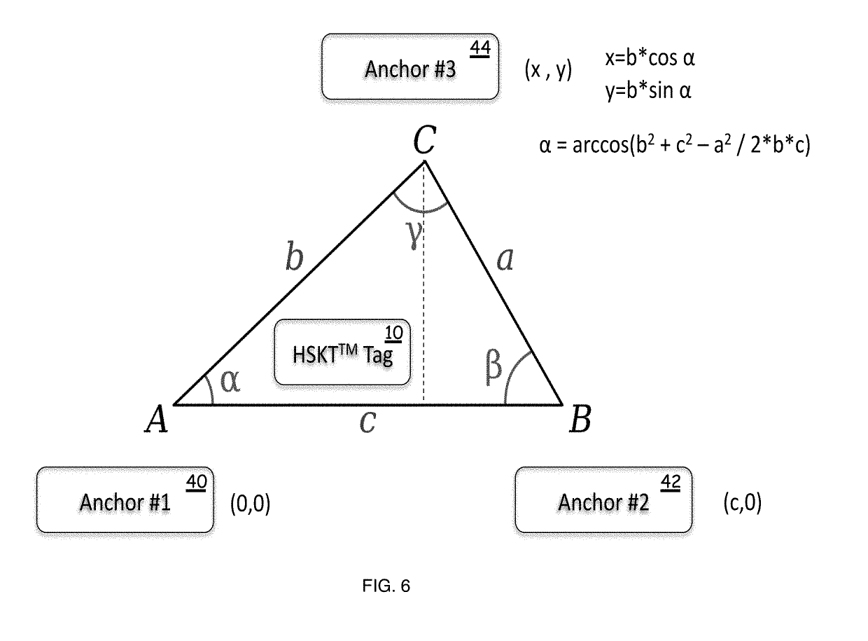

FIG. 6 is a block diagram that illustrates operation of an automatic anchor location determination algorithm by a plurality of anchors according to one embodiment. In order for the trilateration algorithm to proceed, the positions of the anchors must be manually measured or the auto anchor location algorithm can be used.

The steps to automatically determine the coordinates of each of the anchors 40-44 is as follows.

J. When the anchors are initially placed in their respective locations, it is assumed they will be placed in a manner similar to what is shown in FIG. 6. For example, here in FIG. 6, they are placed in a triangular configuration about the tag/processor 10. Disposing the anchors 40-44 in this pattern limits the complexity required by the algorithm.

K. The three anchors 40-44 use the TOA algorithm to determine the distance between each other. These distances are embedded into the TOA message and this later allows the tag/processor 10 to determine where the anchors are located.

L. The tag/processor 10 extracts the distances marked a, b and c from the TOA message.

M. Anchor 40 (anchor #1) is assumed to be at position (0,0) in the local coordinate system.

N. Anchor #2 (anchor 42) is assumed to be at position (c,0) in the local coordinate system.

O. The x position for Anchor #3 (anchor 44) is calculated as x=b*cos α. The y position of Anchor #3 is calculated as y=b*cos α. Anchor #3 is then located at (x, y). P. If the optional GPS position system 22 is available then the local coordinates can be converted into global coordinates. This fixes the location to a specific place on the earth's surface. Because the GPS coordinates can vary within the error range or tolerance of GPS systems, processor 12 employs a Kalman filter (by executing the computer instructions in memory 13 in one embodiment) to determine an accurate GPS coordinate that is then used in relation to the UWS based coordinates previously determined as described above.

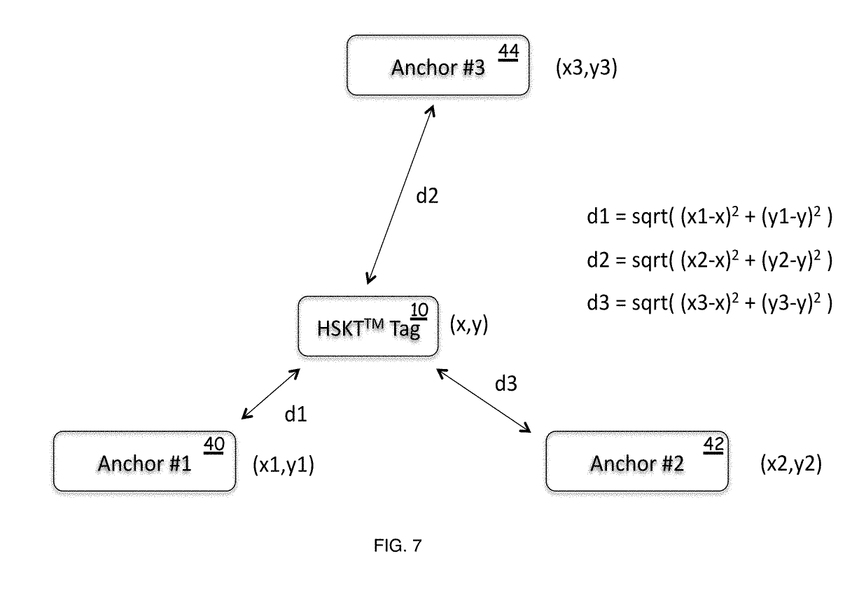

FIG. 7 is a block diagram that illustrates operation of a trilateration algorithm by a plurality of anchors according to one embodiment. The process of determining a position from a set of range measurements is called trilateration. In order to determine the position (x,y) of tag/processor device 10, three non-linear equations have to be solved simultaneously. Initially, a Least Squares approach is used to get a first estimate because it is very fast. Then this estimate is used as a starting point for subsequent calculations using the Newton Method. While the Newton Method gives a more accurate result, but is very time consuming and utilizes more computing resources. Accordingly, using the first estimate with the Least Squares approach speeds up the Newton Method considerably because the combined process brings resolution more promptly. Using the Newton Method is extremely helpful when the tag is outside of the triangle created by the anchors. Using only the Least Squares approach would lead to unacceptable errors.

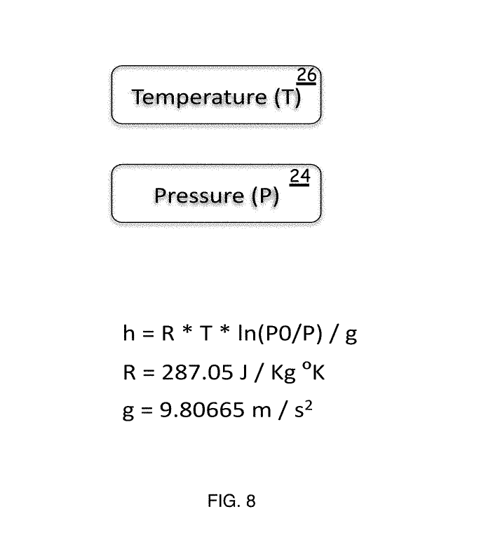

FIG. 8 is a block diagram that illustrates operation of an altitude algorithm according to one embodiment. The information from precision temperature 26 and pressure 24 sensors are used to determine the relative height of the tag/processor device 10 above the ground. During initialization, a known height is used to calibrate the relative height. Then the change in pressure is constantly used to determine height changes. FIG. 8 illustrates the formula to calculate relative height (h) based on the pressure and temperature indications produced by sensors 24 and 26, respectively.

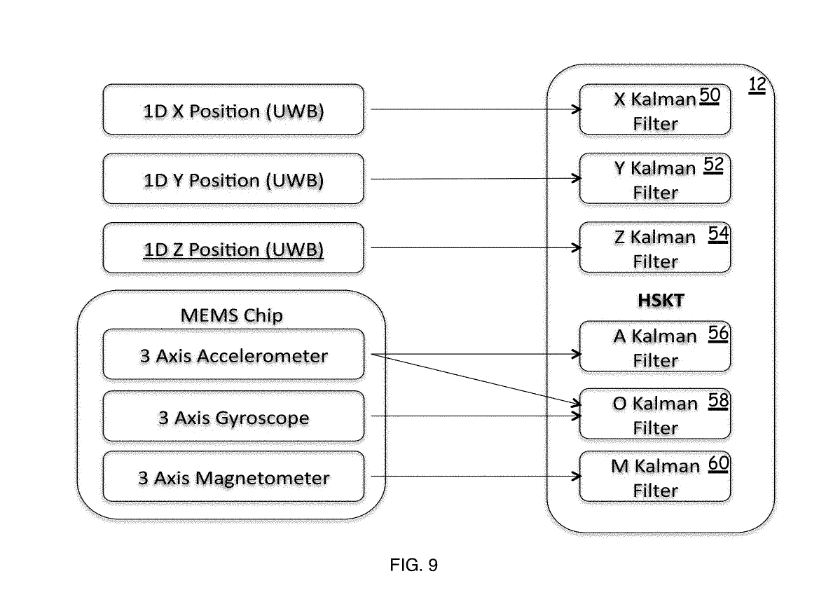

FIG. 9 is a functional block diagram that illustrates a location determination processing block that includes a plurality of Kalman filters according to one embodiment that utilizes the various values derived by circuitry as described above.

The HSKT™ Algorithm performed by processor 12 of tag/processor device 10 comprises multiple Kalman filters that are used to combine all the incoming data and/or prior calculations into a very precise absolute position and orientation (attitude). The first three Kalman filters 50, 52 and 54 are used to generate a 3D position (x, y, z) at a 200 Hz (200 times per second) rate or faster. These three filters are configured to be independent to support independent tuning or adjustment of the filters.

Kalman filter 56 is used to estimate the 3D position for very short periods of time in between based on updated X, Y and Z data produced by the Kalman filters 50-54. There are three main reasons for this:

1. Due to the excessive bias and thermal noise of the MEMS accelerometer the position estimate obtained from the accelerometer should only be used for very short periods of time. Otherwise the accumulated error can exceed the precision specification of the system.

2. If the signal quality of any of the anchors drops below a minimum threshold for a brief period of time, then the 3D position estimation from Kalman filter 56 is used instead of the estimate from Kalman filters 50 and 52.

3. If the change in position estimation from Kalman filter 56 is below a specific threshold (broken down by x,y and z axis) then motion is assumed to be stationary on that axis and the change from any of the Kalman filters 50-54 will be ignored.

Kalman filter 58 is used to estimate orientation (attitude) by combining (fusing) the accelerometer and gyroscope data together using these steps:

Q. Accelerometer data is converted to roll and pitch angles and then to quaternion representation.

R. Gyroscope data is converted to quaternion representation.

S. The gyroscope data goes into the state transition matrix and is used to calculate the state estimate.

T. The accelerometer data is used for each new measurement.

U. The new estimated orientation (xhat) is calculated.

Kalman filter 60 is used to initialize and periodically calibrate Kalman filter 58. All of the Kalman filters follow these general steps:

Set initial values: xhat0=0, P0=0

V. Mk=ΦkPk−1ΦkT+Qk
(compute error covariance before measurement update)

W. Kk=MkHT(HMkHT+Rk)−1 (compute kalman gain)

X. Xhatk=ΦkXhatk−1+Kk (zk−HΦkXhatk−1) (compute new estimate)

Y. Pk=(I−KkH)Mk
(compute error covariance after measurement update)

xhat=state you are trying to estimate

Φk=[1 Ts; 0 1] (transition matrix example for X and Y Kalman filters)

Qk=[90.3 0; 0 2000] (process noise example for X and Y Kalman filters)

Rk=[900]
(measurement variance for X and Y Kalman filters)

zk=new sensor measurement

H=[1 0]

(measurement transition matrix example for X and Y Kalman filters—only position is measured)

Ts=approximately 16.7 ms (Kalman filter example update time for 60 Hz operation)

It should be understood that the Kalman filters are generated by processor 12 that executes computer instruction that define the steps and logic for generating the Kalman filters in one embodiment. Alternatively, such Kalman filters may be implemented in hardware either by discrete logic, a field programmable gate array, an application specific processor, or any combination thereof. Similarly, any portion of the steps described herein may be similarly implemented as an alternative to a processor executing instructions stored in memory.

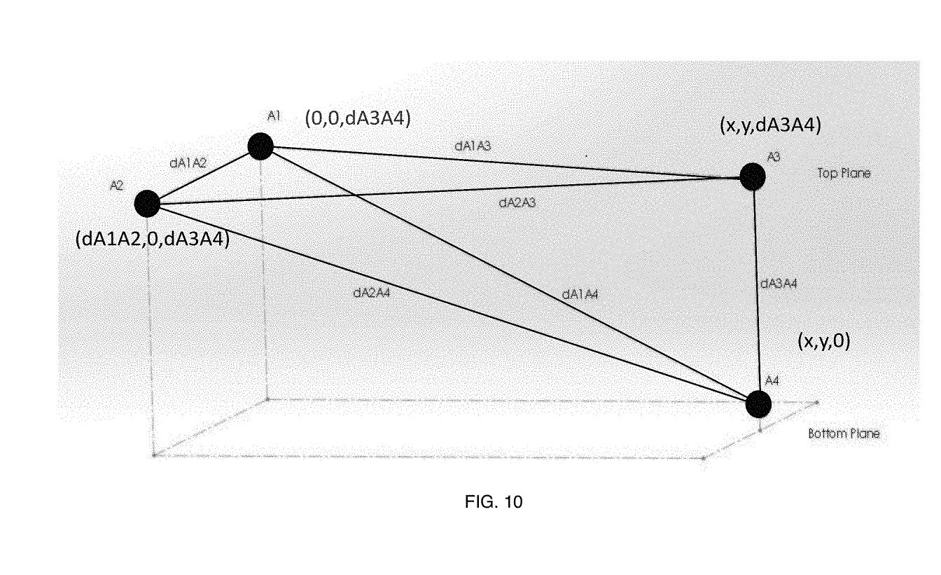

FIG. 10 is a diagram used to illustrate a 3 Dimensional (3D) Auto Anchor Location Algorithm according to one embodiment. The 3D Auto Anchor Location Algorithm proceeds similar to the 2D Auto Anchor Location Algorithm except there is a fourth anchor.

The first three anchors, A1, A2 and A3 are typically placed on the same top plane, but it is not a requirement. The first three anchors x and y coordinates are determined using the 2D Auto Anchor Location Algorithm. The fourth anchor, A4 is typically placed at the same x and y coordinate at anchor A3, but it is not a requirement. The height of the top plane is calculated by measuring dA3A4 using anchors A3 and A4. This height can also be calculated from dA2A4 and dA2A3 where dA3A4=sqrt(dA2A4̂2−dA2A3̂2). Also dA1A4 and dA1A3 could be used where dA3A4=sqrt(dA1A4̂2−dA1A3̂2).

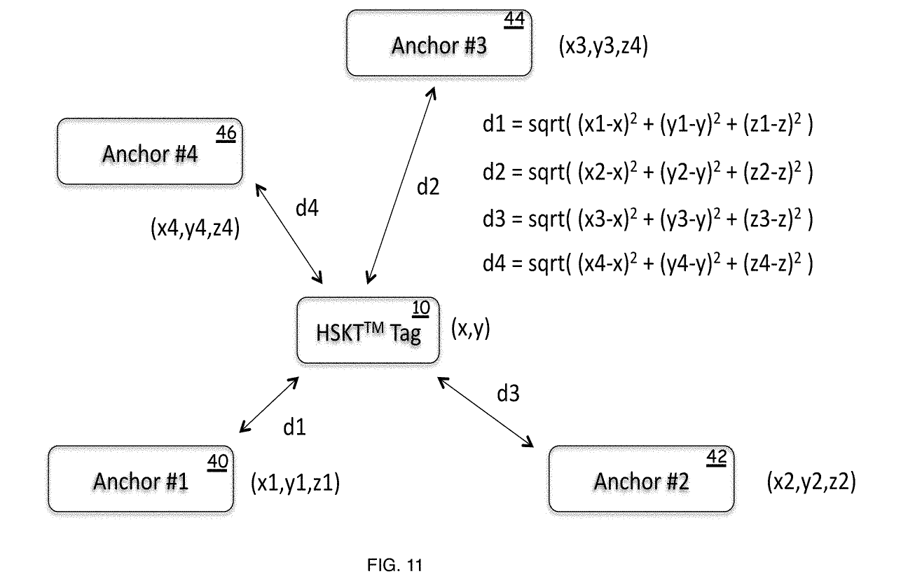

FIG. 11 is a block diagram that illustrates a method for a 3D Trilateration Algorithm. The process of determining a position from a set of range measurements is called trilateration. In order to determine the tag/processor device 10 position (x,y,z), four non-linear equations have to be solved simultaneously. A Least Squares approach is used to get a first estimate because it is very fast. Then this estimate is used with the Newton Method that gives a more accurate result, but is very time consuming. The first estimate speeds up the Newton Method considerably. Using the Newton Method is extremely helpful when the tag is outside of the triangle created by the anchors. Using only the Least Squares approach would lead to unacceptable errors.

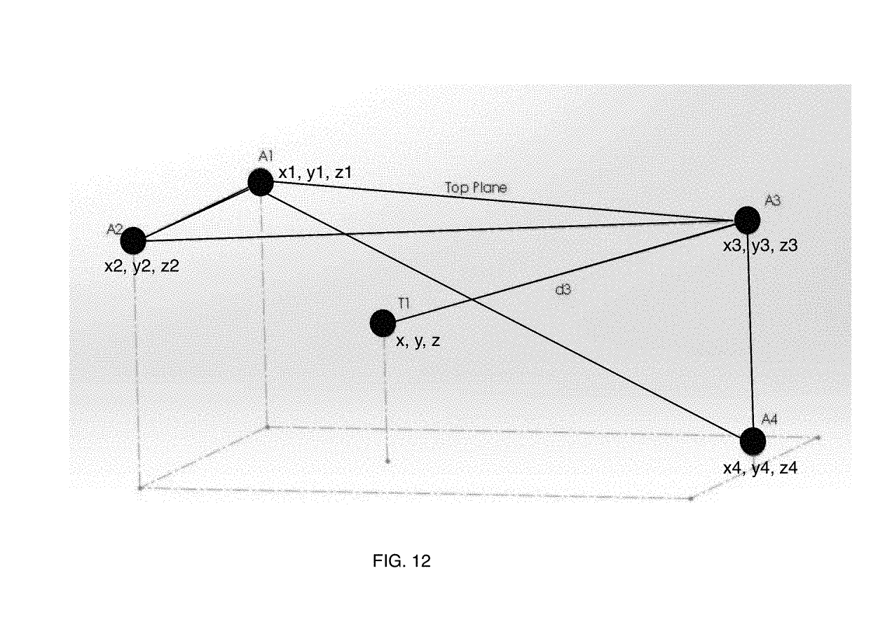

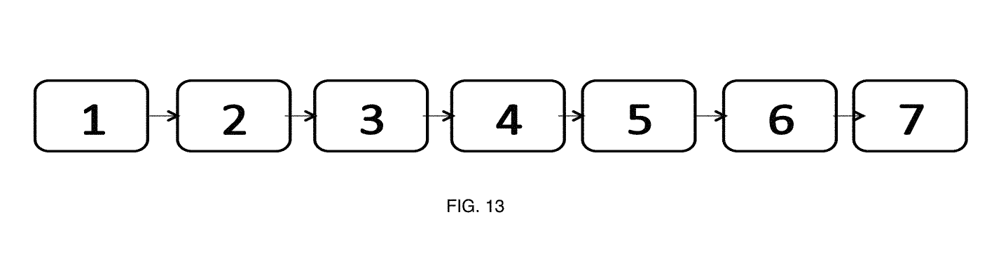

FIG. 12 is a diagram used to illustrate operation of a 3 Dimensional (3D) Trilateration Algorithm according to one embodiment. The process of determining a position from a set of range measurements is called trilateration. In order to determine the tag/processor device 10, 3D position (x,y,z), four non-linear equations have to be solved simultaneously as illustrated in FIG. 11. A Least Squares approach is used to get a first estimate because it is very fast. Then this estimate is used with the Newton Method that gives a more accurate result, but is very time consuming. The first estimate speeds up the Newton Method considerably. Using the Newton Method is extremely helpful when the tag is outside of the triangle created by the anchors. Using only the Least Squares approach would lead to unacceptable errors.

Here, four anchors 40, 42, 44 and 46 are being tracked. Accordingly, four non-linear equations shown below are solved to determine x, y and z of the tag. D1 is the distance between tag/processor 10 and anchor 40. D2 is the distance between tag/processor 10 and anchor 42.

D3 is the distance between tag/processor 10 and anchor 44. D4 is the distance between tag/processor 10 and anchor 46.

d1=sqrt((x1−x)2+(y1−y)2+(z1−z)2) (7)

d2=sqrt((x2−x)2+(y2−y)2+(z2−z)2) (8)

d3=sqrt((x3−x)2+(y3−y)2+(z3−z)2) (9)

d4=sqrt((x4−x)2+(y4−y)2+(z4−z)2) (10)

Notice anchor 46 is placed at a different elevation than anchors 40-44 in order to get a precise z location of the tag. The elevation difference should cover the range of movement in the z axis of the tag. The system will still work if the tag is outside of the triangle created by anchors 40-44, but the precision will start to decrease as the tag get farther away from the triangle. The tag/processor 10 can also be tracked at an elevation higher than anchor 44 or lower than anchor 46, but the precision will decrease as the tag gets farther away from either anchor's elevation.

FIG. 13 is a functional block diagram of a system and method that illustrates operation according to one embodiment.

Block 1—Anchors are Powered ON

When the anchor is first powered ON, it determines which architecture it will be running in and if it is the Master. Next the anchor determines its identity and if any other anchors are ON and which communication channel is being used. Then it waits until the other two anchors are powered ON in a 2D system or when the other three anchors are powered ON in a 3D system.

Block 2—Auto Calibration (Optional)

If auto calibration is selected and all the anchors are powered ON, then A1 determines the distance to A2 and A4 (3D system only). A2 determines distance to A3 and A4 (3D system only). A3 determines distance to A1 and determines distance to A4 (3D system only). All of these distances are stored in the message so each anchor in the chain will know all the previously calculated distances.

A1 then calculates all the coordinates of the other anchors per the Auto Anchor Location Algorithm and sends the coordinates to all the other anchors.

Block 3—Anchor Listening

If no tags are currently present then the anchors go into a low power listening mode.

Block 4—Tag/Processor Device is Powered ON

When the first tag is powered on, it finds out which channel the anchors are using and then it requests their coordinates. In the case of multiple tags using the architecture #2 where the anchor is master, the tag requests which time slot it is supposed to use in a Time Division Multiple Access (TDMA) scheme. In the case of just one tag using architecture #1 then the tag starts with A1 and starts the ranging. It then proceeds to A2, A3 and A4 (3D system). This sequence then continues to repeat.

Block 5—Ranging Algorithm

Once all the distances have been measured to all the anchors, the ranging algorithm can start as described in the Trilateration Algorithm. Each new distance to a specific anchor is put into an array and then a median filter is run to eliminate any bad measurements.

Block 6—HSKT™ Algorithm

Each new set of coordinates are fed into the HSKT™ Algorithm to give cm level or greater precision.

Block 7—Adaptive Acceleration Low Pass Filter (Optional)

If higher precision or smoother output is desired then each set of coordinates from the HSKT™ Algorithm are fed into the Adaptive Acceleration Low Pass Filter.

Adaptive Acceleration Low Pass Filter

The embodiments of the invention may include an Adaptive Acceleration Low Pass Filter to smooth imagery that is displayed that is based on precise location determination information and/or stored imagery related information.

Given:

Linear acceleration in x, y and z (gravity removed).

HR=High range for filter alpha.

LR=Low range for filter alpha.

ratio=Ratio of the amount of acceleration to consider in filter.

alpha=HR−ratio*acceleration_magnitude

x=alpha*prev_x+(1−alpha)*x

$$R = [ \begin{matrix}1 - 2 {q}_{j}^{2} - 2 {q}_{k}^{2} & 2 ( {q}_{i} {q}_{j} - {q}_{k} {q}_{r} ) & 2 ( {q}_{i} {q}_{k} + {q}_{j} {q}_{r} ) \\ 2 ( {q}_{i} {q}_{j} + {q}_{k} {q}_{r} ) & 1 - 2 {q}_{i}^{2} - 2 {q}_{k}^{2} & 2 ( {q}_{j} {q}_{k} - {q}_{i} {q}_{r} ) \\ 2 ( {q}_{i} {q}_{k} - {q}_{j} {q}_{r} ) & 2 ( {q}_{j} {q}_{k} + {q}_{i} {q}_{r} ) & 1 - 2 {q}_{i}^{2} - 2 {q}_{j}^{2}\end{matrix} ] \qquad ( 11 )$$

Once the x and y (2D) or x, y and z (3D) coordinates have been determined form the HSKT™ algorithm they are then fed into the Adaptive Acceleration Low Pass Filter

in order to obtain smooth motion as described below:

AA. Linear acceleration is calculated.

1. Obtain acceleration vector from A Kalman filter a=[ax,ay,az].

2. Obtain normalized orientation quaternion from O Kalman filter q=[q0,q1,q2,q3].

3. Calculate the rotation matrix R using the quaternion from #2 above and the formula shown in the slide above.

4. Calculate transformed gravity vector g′=g*R where g is local gravity vector. g is approximately equal to <0,0,−9.81>

5. Calculate linear acceleration vector a′=a−g′=[lax,lay,laz];

AB. Apply Adaptive Acceleration Low Pass Filter

1. Calculate magnitude of acceleration in the XY plane by mag_xy=sqrt(lax̂2+laŷ2).

2. Calculate low pass filter alpha_xy=HR−ratio_xy*mag_xy.

a. HR is an adjustable constant. The higher the value the smoother the output, but latency increases. Typical value is 0.99.

b. ratio_xy is an adjustable constant ratio. The higher the value the lower the value of alpha_xy, which in turn decreases the latency and prevents fast motions from being filtered out.

c Clamp the alpha_xy at a minimum value with an adjustable constant LR. This prevents alpha_xy from getting too low and prevents excessive noise from entering the calculation.

d. The new x coordinate is calculated at x=alpha_xy*prev_x+(1−alpha_xy)*x.

e. The new y coordinate is calculated as y=alpha_xy*prev_y+(1−alpha_xy)*y.

f. Calculate magnitude of acceleration in the Z axis by mag_z=abs(laz). Where abs is the absolute function.

g. For the z axis a new low pass filter alpha_z=HR−ratio_z*mag_z is calculated similar to above.

h. Then the new z coordinate is calculated at z=alpha_z*prev_z+(1−alpha_z)*z.

i. Finally previous values are updated for the next iteration.

l. Prev_x=x, prev_y=y, prev_z=z

### TOA Master for the Various Embodiments

The Tag/processor 10 is the master using TOA algorithm in many embodiments. This is not a requirement, however. The anchor (anyone of the 3 or 4) may be the master using TOA algorithm in one alternative embodiment. In yet another embodiment, multiple tags are being tracked using TOA algorithm and a time division multiple access (TDMA) scheme.

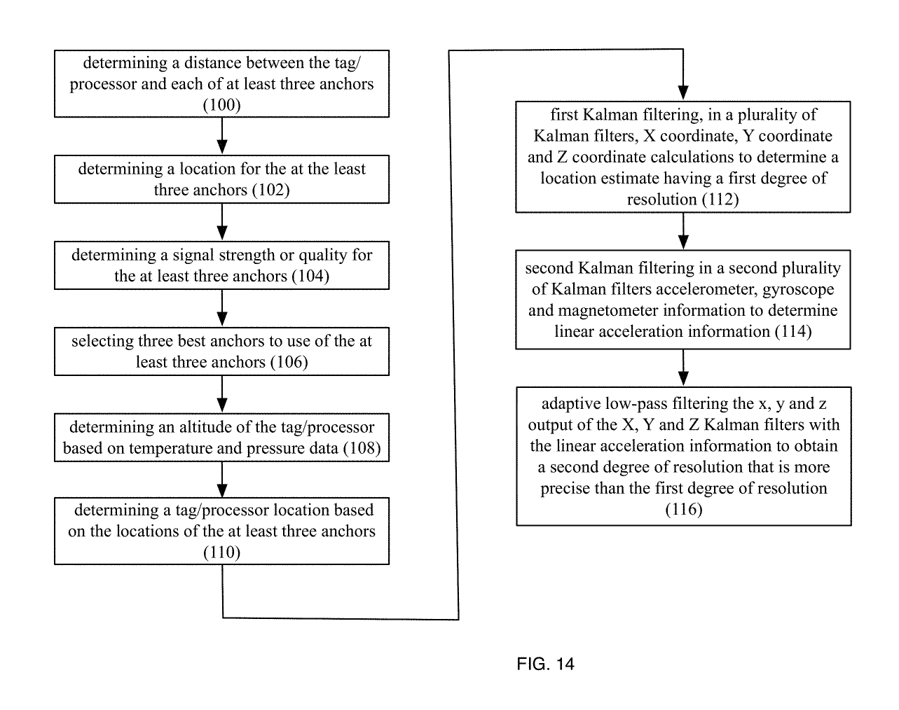

FIG. 14 illustrates a method for estimating a location according to one embodiment of the invention. The method includes determining a distance between the tag/processor device and each of at least three anchors (100). The method also includes determining a location for the at the least three anchors (102). In one embodiment, determining the location for each anchor includes receive a communication signal from each anchor that specifies its location. Optionally, the method also includes determining a signal strength or quality for the at least three anchors (104). In an embodiment having more than three anchors, the signal strength or quality is used by the tag/processor device to select three anchors that are to be used as a part of the location determination process. Accordingly, if there are more than three anchors, the method includes selecting three best anchors to use of the at least three anchors (106). The method also includes determining a temperature and air pressure of the ambient conditions immediately around the tag/processor device (108). In the described embodiment, the tag/processor device includes temperature and pressure sensors that send temperature and pressure information to the processor of the tag/processor device. Further, the method includes receiving and processing location information with an ultra-wideband radio transceiver.

Once the three anchors are selected, their locations are known, and a distance between the tag/processor device and the three anchors has been determined, and an altitude of the tag/processor device has been determined, the method includes determining a tag/processor device location based on the locations of the at least three anchors as well as at least one of the temperature and pressure information (110).

The initial location information, in terms of X, Y and Z coordinates is then Kalman filtered in first, second and third Kalman filters, respectively, to determine a Kalman filtered location estimate that is more precise than the initial location determination and more precise, in at least one embodiment, than any of the sensor data, the Kalman filtered location estimate having a first degree of resolution (112).

In one embodiment of the invention, the method also includes second Kalman filtering in a second plurality of Kalman filters, accelerometer, gyroscope and magnetometer information (received from a MEMs chip in one embodiment) to determine linear acceleration information (114). Finally, the method includes adaptive low-pass filtering the x, y and z output of the X, Y and Z Kalman filters with the linear acceleration information to obtain a second degree of resolution that is more precise than the first degree of resolution (116).

The method according to one embodiment includes generating an updated location estimate based on updated information for X, Y and Z coordinate information that is based upon updated ultra-wideband (UWB) X position information that has been Kalman filtered for each coordinate. The ranging information or distance is calculated using a time of arrival measurements that are compared to indicated time of transmission information that is indicated by the anchors. In one embodiment, the calculated distance is adjusted with a calibration factor that is based upon the calculated distance to determine an adjusted distance that is determined for each of the anchors in relation to the tag/processor device. A trilateration algorithm is used to determine the location of each anchor and of the tag/processor device. The trilateration algorithm uses at least one of a Least Squares calculation and a Newton Method calculation. In one embodiment, the algorithm uses a Least Squares calculation and subsequently a Newton Method calculation.

In the described embodiment, a Kalman filtering system includes a first Kalman filter for Kalman filtering a first type of coordinate information, a second Kalman filter for Kalman filtering a second type of coordinate information, a third Kalman filter for Kalman filtering a third type of coordinate information and at least one (e.g., a fourth) Kalman filter for Kalman filtering at least one of accelerometer, gyroscope and magnetometer information. In one embodiment, the Kalman filtering system includes the fourth and a fifth Kalman filter wherein the fourth Kalman filter is for Kalman filtering one of said accelerometer and said gyroscope information and wherein the fifth Kalman filter is for Kalman filtering both the accelerometer and gyroscope information. In yet another embodiment, a sixth Kalman filter for Kalman filtering said magnetometer information is included.

This filter and method illustrated herein including, among other figures, is for a system that is operable to track motion within a second degree of resolution that, in one embodiment, is as precise as a millimeter. Such precise information is beneficial for many applications including but not limited to those identified or suggested below at the end of the Detailed Description.

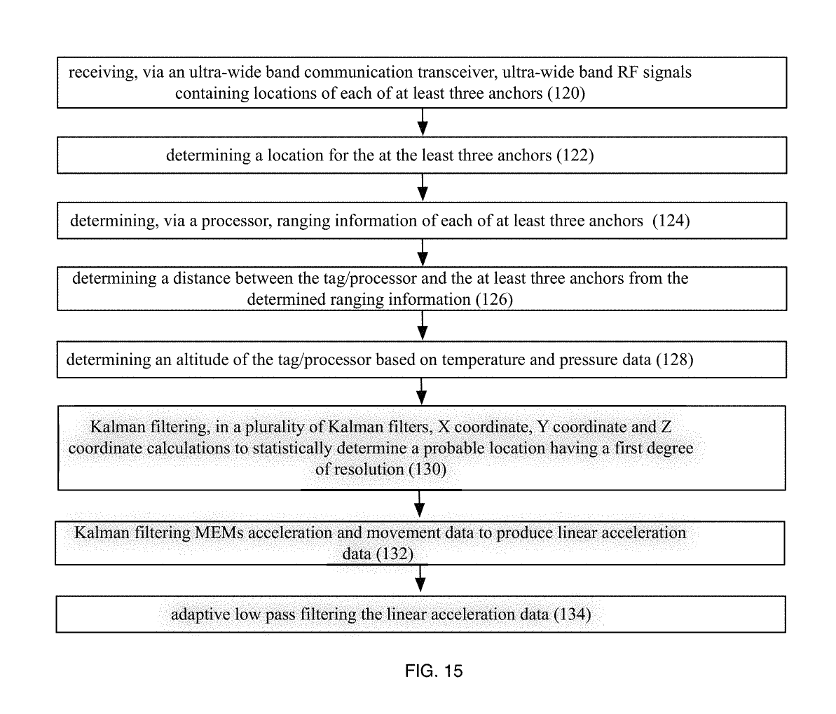

FIG. 15 is a flow chart that illustrates a method for determining a tag/processor device location according to one embodiment. The method commences with receiving, via an ultra-wide band communication transceiver, ultra-wide band RF signals containing locations of each of at least three anchors (120). Thereafter, the method includes determining, via a processor that processes received communication signals, location information specified within the received communication signals for the at least three anchors (122). The method further includes ranging information of each of at least three anchors by transmitting and receiving ultra-wideband communication messages via the ultra-wide band device and determining an associated transmission time of flight between the tag/processor device and the at least three anchors to determine the ranging information (124). The method also includes determining distances between the tag/processor device and the at least three anchors and storing the determined distances from the determined ranging information (126). As a part of determining the tag/processor device location information, the method further includes determining an altitude of the tag/processor device based upon received pressure and temperature data that are produced by pressure and temperature sensors (128).

The method for determining a location estimate further comprises Kalman filtering, in a plurality of Kalman filters, X coordinate, Y coordinate and Z coordinate calculations from initially determined location information to statistically determine a probable location having a first degree of resolution (130). The method also includes Kalman filtering acceleration and movement data to produce linear acceleration data (132). In one embodiment, such movement data is received from a MEMs chip though such data may be received from other sources as well. Finally, the method includes adaptive low pass filtering the linear acceleration data (134). The outputs of the adaptive low pass filtered linear acceleration data is a second location estimate having a second degree of resolution that is much greater than the first degree of resolution of the initially determined location estimate.

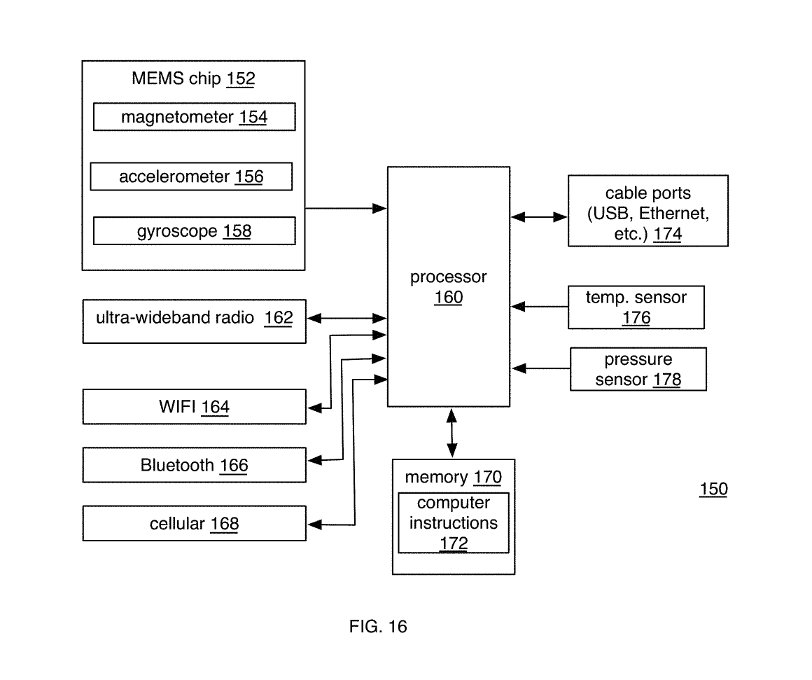

FIG. 16 is a functional block diagram of a tag/processor device according to one embodiment. A tag/processor device 150 includes a MEMS chip 152 that further includes a magnetometer 154, an accelerometer 156 and a gyroscope 158. The MEMs chip 152 produces acceleration and movement data to a processor 160. Processor 160 is further coupled to communicate with and via an ultra-wideband radio 162, a Wi-Fi access point (e.g., one that operates according to I.E.E.E. 802.11 protocols, a personal area network access point or devices such as a Bluetooth device 166. Additionally, processor 160 may be configured to communicate with and via a cellular radio that operates according to one or more voice or data cellular radios 168 utilizing associated protocols. Processor 160 is further coupled to a memory 170 that includes computer instructions that, when executed by processor 160, causes processor 160 (and more generally tag/processor device 150) to operate according to the manner described herein throughout the application but especially in relation to the described methods and processes and equivalents therefor. Processor 160 is further connected to a plurality of cable ports 174 that support one or more various types of connectors and communication protocols including but not limited to USB, Ethernet, etc. Finally, processor 160 is configured to receive temperature information from temperature sensor 176 and pressure information from pressure sensor 178.

In operation, processor 160 communicates via ultra-wideband radio 162 to determine precise ranging information from at least three anchors and executes computer instructions 172 to generate a plurality of Kalman filters that Kalman filter the determined triangulated location based on received ranging information to determine a location with a first degree of resolution. Processor 160 also executes computer instructions 172 to generate a second plurality of Kalman filters that Kalman filter MEMS chip data to generate linear acceleration data. Processor 160 further adaptive low pass filters the linear acceleration data to generate a probable location having a second degree of resolution that is much more precise that the first degree of resolution. As an example, in one embodiment, the first degree of resolution is approximately one centimeter and the second degree of resolution is approximately a millimeter.

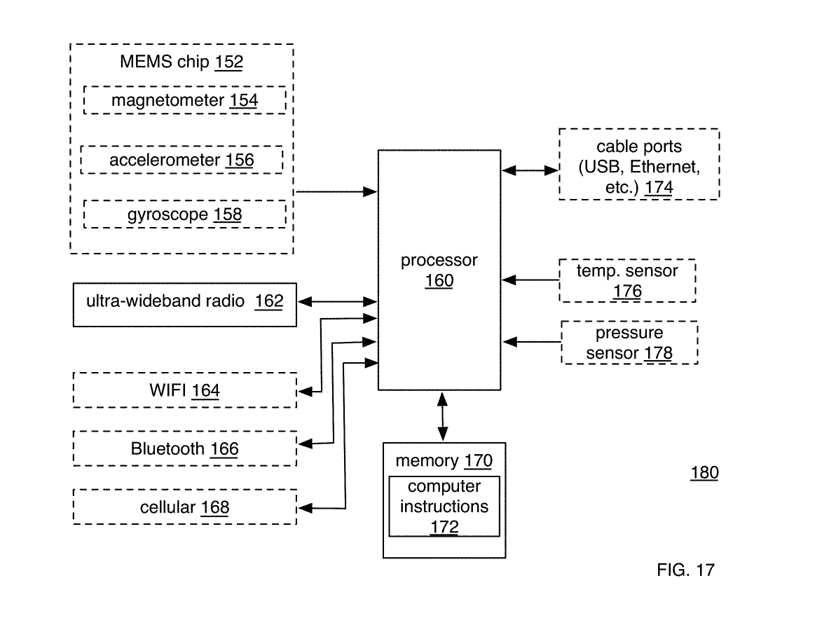

FIG. 17 is a functional block diagram of an anchor in a location determination system that comprises a plurality of anchors and a tag/processor device according to one embodiment. Many of the components or elements of the anchor in FIG. 17 are similar to those of the tag/processor device of FIG. 16 and are similarly numbered. In one embodiment, the anchors 180 may be substantially the same as the tag/processor devices with the same elements. In the described embodiment, however, the anchors are simplified to reduce complexity, cost and/or power consumption. Because the anchors are, by nature, stationary, such anchors may be utilized that do not include MEMS chip 152, the communication radios such as Wi-Fi 164, Bluetooth 166, or cellular radios 168. Ultra-wideband radio 162 is required, however, to support accurate location determination algorithms, especially those within the tag/processor devices. In one embodiment, anchor 180 also does not include the cable ports 174 or the temperature/pressure sensors 176 and 178. In an alternative embodiment, the temperature and pressures sensors 176 and 178 are included so that the altitude of the anchor may be determined as a part of determining its location coordinates.

In operation, anchor 180 determines its location relative to the other anchors utilizing ranging and triangulation process steps as described herein. More specifically, memory 170 includes the computer instructions 172 to enable processor 160 to perform such calculations when executing the computer instructions 172. In one embodiment, all anchors 180 are disposed at a common altitude to essentially define a horizontal plane. Accordingly, the pressure and altitude data from sensors 176 and 178 are not needed. In an alternative embodiment, the anchors 180 include the pressure and altitude sensors 176 and 178. This embodiment does not require the anchors to be placed at the same altitude.

Another point that may be considered is that the anchors do not calculate location information to the second degree of precision like the tag/processor device does in those embodiments that the anchor does not have the MEMS chip 152. That is acceptable, however, because the anchors are stationary. Accordingly, the tag/processor devices are still capable of determining location information with the second degree of precision (e.g., millimeters) because its movement is relative to the stationary anchors.

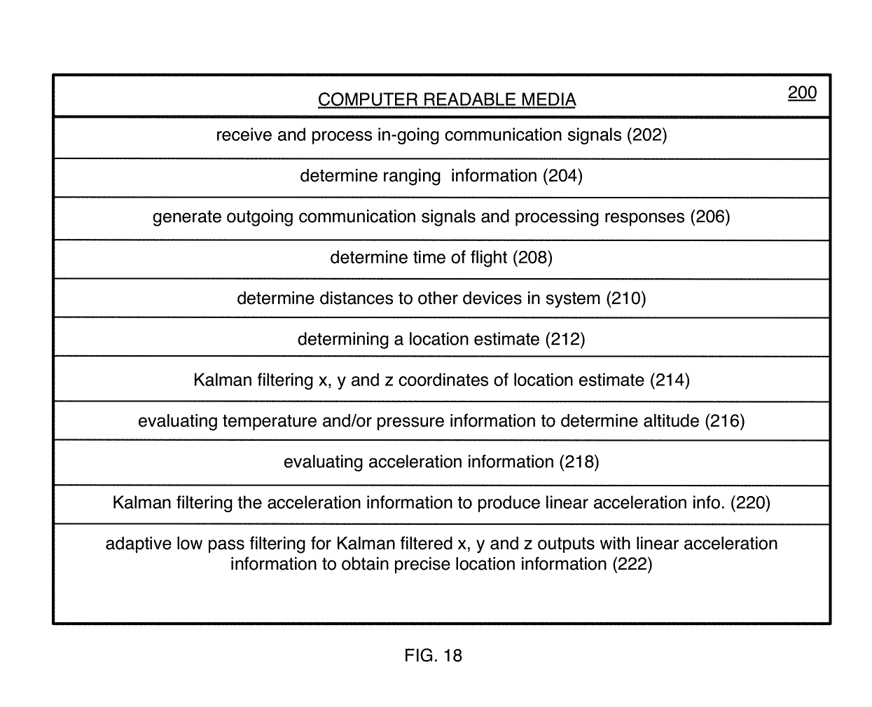

FIG. 18 is a functional block diagram of a computer readable media containing computer instructions that defines operational logic for a processor of a location determination tag/processor according to one embodiment. A computer readable media (CRM) 200 includes computer instructions that, when executed by one or more processors, causes the one or more processors to perform the steps of:

receive ingoing digital communication signals from an ultra-wideband radio containing location information from each of a plurality in the location determination system (202);

determine ranging information (204) of each of the plurality of other apparatuses by:
generating and producing outgoing digital transmission signals and receiving responsive ingoing digital communication signals via the ultra-wideband communication messages (206); and
determining associated transmission time of flight between the apparatus and the plurality of other apparatuses (208);

determining a distance between the apparatus and the plurality of other apparatuses from the determined ranging information (210); and

determining an apparatus location estimate based on the locations and ranging information of the plurality of other apparatuses (212);

Kalman filtering, in a first plurality of Kalman filters, X coordinate, Y coordinate and Z coordinate calculations to statistically determine a probable location having a first degree of resolution (214);

evaluating at least one of temperature and pressure information as a part of determining the probable location (216);

evaluating acceleration information produced by a MEMs device as a part of determining the probable location (218);

defining A and O Kalman filters and for receiving acceleration information from the MEMs device and producing acceleration information to the A and O Kalman and Kalman filtering the acceleration information in the A and O Kalman filters to produce linear acceleration information (220); and

combining outputs of the A and O Kalman filters to determine precise location information (222).

It should be understood that the CRM 200 of FIG. 18 may readily include additional or alternative computer instructions to perform any of the steps described throughout this specification and figures. The CRM 200 may be in the form of an optical disk, magnetic media (including magnetic memory devices), memory of a hard disk drive or other storage device, etc. Furthermore, the computer instructions may also be those stored in association with a location determination device as described herein for execution by at least one processor to determine the precise location information.

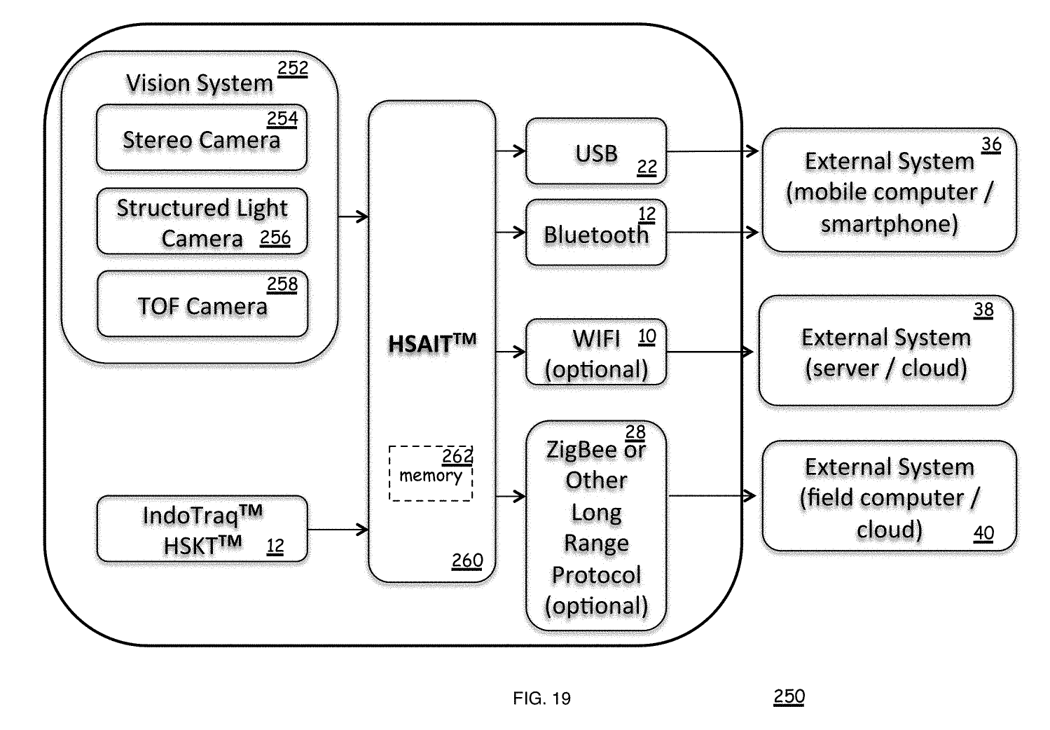

FIG. 19 is a functional block diagram of a high speed artificial intelligence tracking (HSAIT™) system that further includes a vision system for tracking movement according to one embodiment. The HSAIT™ system shown generally at 250 includes a vision system 252 that provides image data to an HSAIT™ processor. Vision system 252 may include any one of a stereo camera 254, a structured light camera 256 or a time-of-flight (TOF) camera 258. In one embodiment, either two or three of these camera systems 254-258 are included.

The HSAIT™ processor 260 may include a single processor or multiple processors or an integrated circuit that has multiple core processors. The HSAIT™ processor 260 is coupled to memory 262 that includes computer instructions that define operations with respect to the described embodiments as well as routine processor operations. The vision system 252 is configured to provide either two-dimensional or three-dimensional image data to HSAIT™ processor 260.

FIG. 19 illustrates a high speed Kalman tracking (HSKT™) location determination processor 12 that communicates with a plurality of sensor types (as shown in FIG. 1) whose data is processed by processor 12 to determine location with a high degree of accurate resolution. Processor 12 is a general purpose or application specific processor configured to operate as a high speed Kalman tracking device that Kalman filters received data from a plurality of sensors to determine precise location information. Processor 12 performs the described functionality including the Kalman filtering of the sensor data to determine precise location information to HSAIT™ processor 260.

The data sensors include a 3-axis gyroscope 14, a 3-axis accelerometer 16 and a 3-axis magnetometer 18. The data from these sensors 14, 16 and 18 are processed by processor 12 along with data from an ultra-wide band position system 20, an optional a 3-axis global positioning system (GPS) 22, a pressure sensor 24, and a temperature sensor 26. In at least one embodiment, processor 12 is operable to generate three dimensional location information that is accurate within 1 cm in one embodiment, though no one piece of information from the sensors/systems 14-26 provide data with that level of precision. Processor 12, shown as HSKT™, combines the data with multiple Kalman filters at high speed (200 Hz or higher) to give a precise (+−1 mm or better) three-dimensional location estimate in yet another embodiment. In either embodiment, one aspect of device 10 is that the final location information is far more precise that the accuracy of any of the sensors that are coupled to deliver sensor data to processor 12 for Kalman filtering and processing.

Processor 12 includes or is coupled to a memory that includes computer instructions that define the operational steps of processor 12. More specifically, the memory includes computer instructions that, when executed by processor 12 cause processor 12 to operate as described herein including, for example, the Kalman filtering, etc., and more generally, to perform the necessary steps described herein to perform the precise location determination functionality described herein.

Once the location estimate is calculated, the values are transmitted from processor 12 to HSAIT™ processor 260. HSAIT™ processor 260 further receives 2 or 3 dimensional image data from one or more cameras as previously described. HSAIT™ process 260 combines relative movement information determined from the image data with the precise location information received from processor 12 to determine accurate location information. This information is then produced out of the system to an external device, if desired, using one of USB 28, Bluetooth 30, Wi-Fi 32 (I.E.E.E. 802.11 (a-n), 802.15, ZigBee 34, or other communication technologies such as cellular communications.

FIG. 19 generally shows the overall layout of a camera based location determination system combined with a precision location determination system. Images from the vision system enter the deep convolutional neural network which extracts 2D or 3D points from each image. These points are used to generate relative position and orientation changes from image to image in time. Absolute position and orientation data is fed from the HSKT™ system along with statistics or signal quality metrics to provide information about the quality of the wireless signals. A second deep neural network is used to recognize patterns in the data to determine when the data should be trusted and used. Finally the relative position/orientation of the camera(s) is combined with the accurate absolute position/orientation data of the HSKT™ system (e.g., from processor 12). This third neural network is able to correct errors due to long term drift in the relative data and correct short term errors in the absolute data. The final output of this algorithm provides accurate high speed tracking data.

More specifically, in one embodiment, vision data from one or more cameras on the left are combined with a high speed Kalman tracking (HSKT™) technology using multiple deep neural networks (artificial intelligence) at high speed (30 Hz or higher) to give a precise (sub millimeter) location estimate. Once the location estimate is calculated, the values can be transmitted out of the system using USB, Bluetooth, WIFI, ZigBee, or other communication technologies. The benefits of this system are:
1. Improved vertical tracking.
2. Improved multi-axis tracking in the presence of wireless noise or obstacles that block the line of sight (LOS) of anchors in the HSKT™ system.

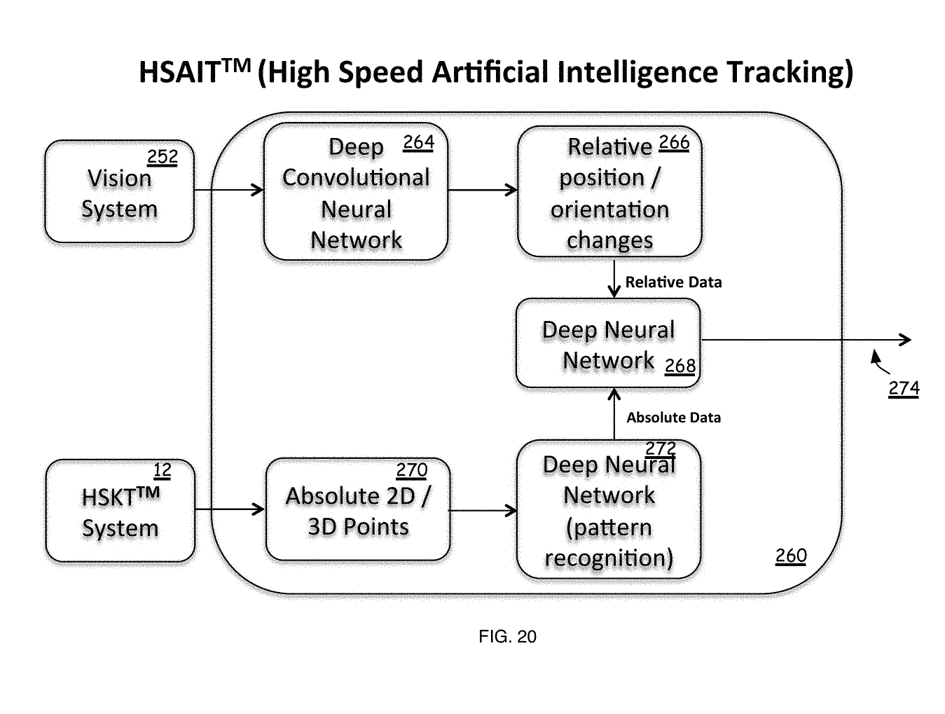

FIG. 20 is a functional block diagram of an HSAIT™ system according to one embodiment. Images from the vision system 252 are produced to the HSAIT™ processor 260 and, more specifically, to a deep convolutional neural network 264. The deep convolutional neural network extracts 2D or 3D points from each image. These points are used to generate relative position and orientation changes from image to image in time. While such systems can be very precise in a relative sense (relative to a last frame), drift in the data can occur over time thereby leading to inaccuracy in terms of absolute position and orientation.

Accordingly, absolute position and orientation data is fed from the HSKT™ system. Also included is statistics about the quality of the wireless signals. A second deep neural network is used to recognize patterns in the data to determine when the data should be trusted and used.

Finally, the relative position/orientation is combined with the accurate absolute position/orientation data. This third neural network is able to correct errors due to long term drift in the relative data and correct short term errors in the absolute data. The final output of this algorithm provides accurate high speed tracking data.

More specifically, in the described embodiment, vision system 252 provides either two-dimensional or three-dimensional data to deep convolutional neural network 264 that extracts either 2D or 3D data points from each image and produces the data points to processing block 266 for determining the relative position and orientation changes. The relative position and orientation changes are then produced to deep neural network 268. At the same time that such processing is occurring, processor 12 of the HSKT™ system provides location data to block 270 that determines absolute 2D/3D points that are, in turn, produced to deep neural network 272 that utilizes pattern recognition techniques to provide absolute location information to deep neural network 268. Deep neural network 268 then processes the relative position data received from block 266 as well as the absolute position data received from block 272 to determine location information that is produced at output 274.

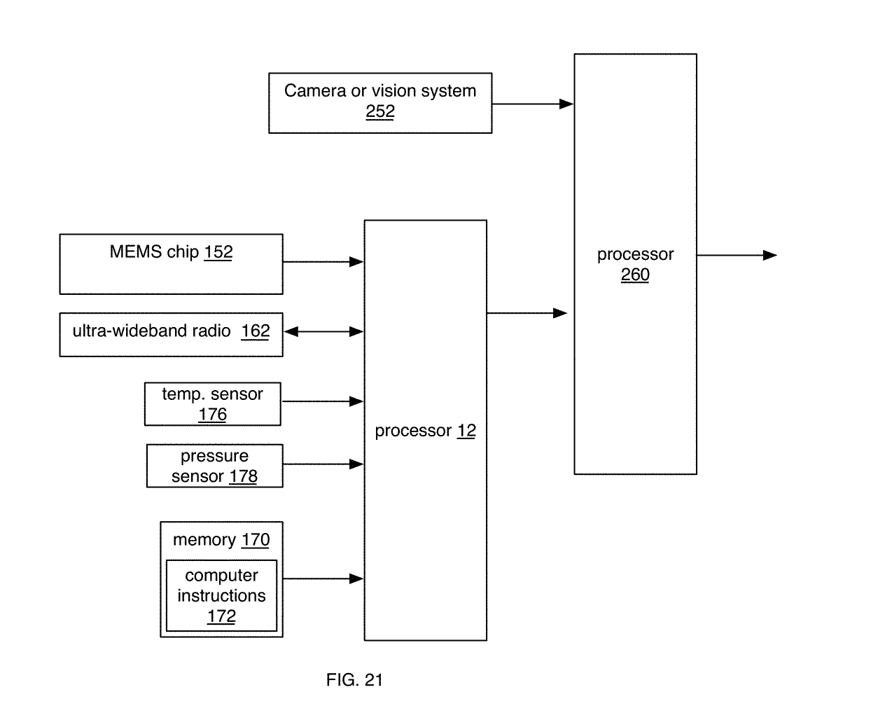

FIG. 21 is a functional block diagram that illustrates additional details of how an HSKT™ system is combined with an HSAIT™ system to provide precise location information. As may be seen, a processor 12 is coupled to communicate with a MEMs chip 152, an ultra-wideband radio 162, a temperature sensor 176, a pressure sensor 178, and a memory 170 that includes computer instructions 172. Operation and the structure of these elements is as described before. Processor 12 processes the data from these sensors and devices as described previously and produces absolute location information have a high resolution as previously described. Here, however, the absolute location information is produced to a processor 260. Occasionally, however, an anomaly occurs because of an external factor such as multi-path interference or fading thereby impeding the ability of processor 12 to timely produce the precise location information for a short period until the interference is cleared. Processor 260, however, is further coupled to a camera system 252 to receive image data therefore which provides very accurate relative location information (relative to a prior frame). Using a plurality of neural networks, processor 260 is configured to evaluate the absolute location information from processor 12 as well as the relative location information that can be determined from the data from camera 12 to determine very precise location information notwithstanding an anomaly in the absolute location information produced by processor 12 due to temporary interference. Processor 260 may comprise a single processor that executes computer instructions to operate one or more neural networks to process and evaluate data or may utilize a plurality of processors or processor cores to perform the operations described herein.

The internal algorithms of both of optical or vision tracking systems such as VO and SLAM systems match keypoints from one image frame to another in order to determine the relative rotation and location changes. Due to a range of issues such as occlusions, poor contrast, poor texture, lighting and dynamic scenery changes, these keypoints are often not able to be matched from image frame to frame. Thus, tracking is lost. When tracking is lost, the optical or vision tracking devices must relocalize to reestablish tracking. For SLAM, for example, a continuous map of the environment is being made. Accordingly, keypoints need to be matched to the previous map points to reestablish the tracking. This searching of keypoint to map points to find these matches requires more computing power than can currently be made available to small, low power electronic tracking devices. As such, there is a need for an optical or vision tracking system to accurately and quickly reestablish its location to resume and reestablish its tracking function. Accordingly, in the described embodiment, a plurality of location determination systems are utilized to allow a device to maintain knowledge of its absolute location as well as its relative location regardless of interference from occlusions, multipath fading, etc.

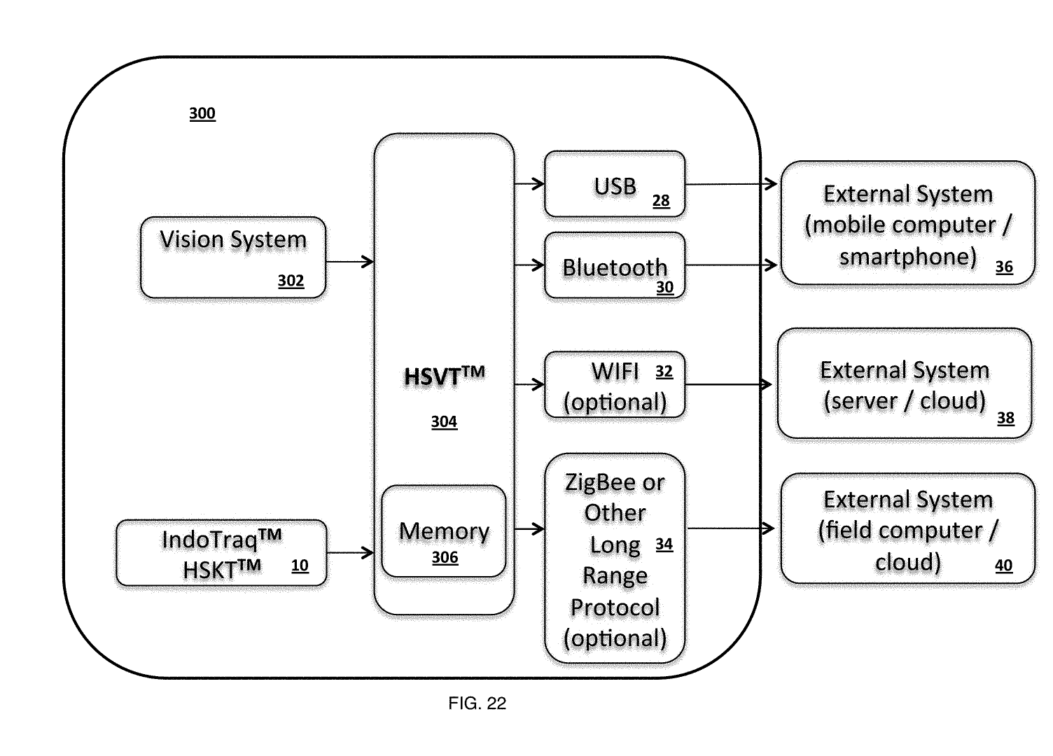

FIG. 22 is a functional block diagram of a high speed vision tracking system that produces absolute location information according to one embodiment of the disclosure. More specifically, FIG. 22 illustrates one embodiment of a high speed location tracking device 300 that includes a plurality of sensor types 10 and 302 whose data is processed by a High Speed Vision Tracking (HSVT™) processor 304 to determine location with a high degree of accurate resolution. Location tracking device 300 includes a Kalman tracking (HSKT™) location determination device 10 that is referenced herein as a tag/processor device 10. A vision system 302 includes any type of optical tracking technology that produces relative location information. HSVT™ processor 304 may be a general purpose processor configured to execute software instructions that define operational logic and algorithms that provide more precise location determination or an application specific processor configured to operate as a high speed location tracking device that Kalman filters received data from a plurality of sensors to determine precise location information. Alternatively, HSVT™ may comprise an application specific integrated processor, field programmable gate array circuitry, discrete circuitry or any combination thereof.

A memory 306 is coupled to deliver computer instructions to processor 304 for execution in the described embodiment. The computer instructions are configured to cause processor 304 to perform the described functionality including receiving the Kalman filtering of the sensor data of sensor 10 as well as the relative location information from vision system 302 to fuse the received location information from devices 10 and 302 to determine precise location information. Such processing may be performed, either in whole or in part, by discrete logic, field programmable gate array logic, the ASIC, processor 304, or any combination thereof.

Generally, a high speed vision tracking system (HSVT™) 300 includes a vision system 302 that produces relative location information using a camera technology to an HSVT™ processor 304. Vision system 302 may be any type of optical, camera or vision based system to tracks movement based upon image data. References to any one of these systems should be understood to include the other types of systems and such terminology may be used interchangeably herein. HSVT™ processor 304 further receives precise location information from an HSKT™ system such as any of the HSKT™ systems 10, 150 and 180 that were previously discussed. In the disclosed embodiment, an HSKT™ 10 produces the precise location information to HSVT™ processor 304. HSVT™ processor 304 is configured to process the precise location information received from an HSKT™ system and relation location information produced by a vision system 302 to determine fused location information that may be as or more precise that the precise location information depending upon error conditions, interference (multipath interference, etc.) and occluded vision information. HSVT™ processor 304 is coupled to or includes memory 306 that, in one embodiment, includes computer instructions that are executed by HSVT™ processor 304 to generate the fused location information. It should be noted that for the functionality described herein as well as structural requirements, the HSVT™ processor 304 may be used interchangeably in all places referring to HSAIT™ processor 260 and vice-versa.

As may be seen, HSVT™ processor 304 is further coupled to produce the fused location information to a device or external system using any known communication technology that is wired or wireless. In the embodiment of FIG. 22, HSVT™ processor 304 is coupled to at least one of a USB port 28, a Bluetooth radio 30, a Wi-Fi radio 32 or a long range protocol radio such as Zigbee radio 34. These communication technologies are similar to those previously discussed herein. One or more of these communication technologies may be utilized to produce the fused location information to an external system 36 such as a mobile computer, user terminal or smart phone, an external system 38 such as a server or cloud device via a packet data network such as the Internet, or a specific external system 40 such as a field computer or cloud device or application.

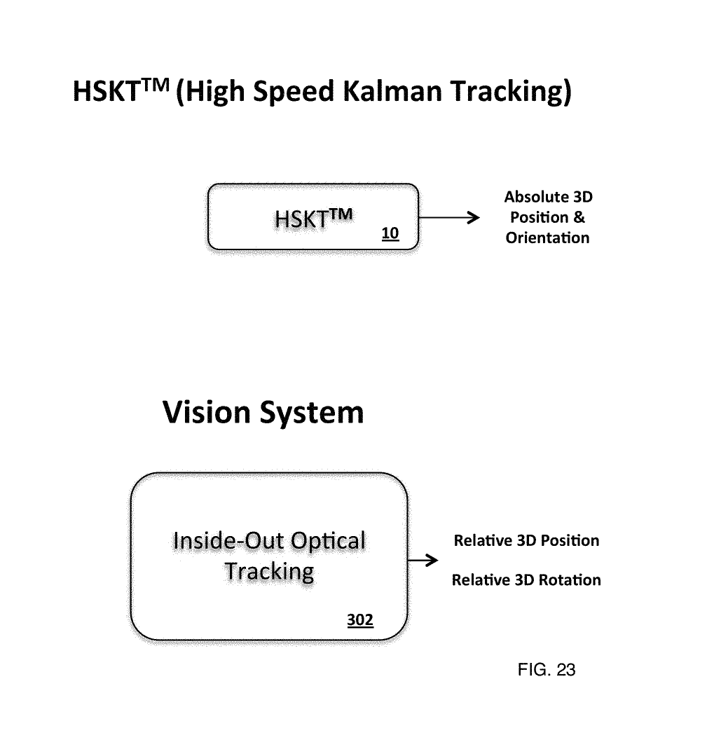

FIG. 23 is a functional block diagram that illustrates functional operation of the HSKT™ tag/processor 10 and the vision tracking system 302 according to one embodiment of the disclosure. As may be seen, HSKT™ tag/processor 10 produces absolute position and orientation information in three dimensions as previously discussed. In perfect operation conditions, the precision of HSKT™ tag/processor 10 may be within a few millimeters. In a scenario in which there are many individuals or objects that create interference such as multipath fading, the precision of HSKT™ tag/processor 10 may diminish. Vision tracking system 302, on the other hand, is one of several types of vision tracking systems that produce very accurate relative position and rotation information in three dimensions so long as there is no occlusion and previously identified keypoints (of an object) may continue to be detected and compared to prior location information for the same keypoints. Occlusion of too many keypoints, however, may cause a vision tracking system to lose tracking. As such, the described embodiment includes both types of location determination systems and logic and circuitry to receive, process and fuse the three dimensional location information. By combining absolute location information from HSKT™ tag/processor 10 and relative location information from vision tracking system 302, location tracking may be maintained even in the face of multipath interference and occlusion. By combining an HSKT™ tag/processor 10 and a vision tracking system 302, sub-millimeter precision may be obtained.

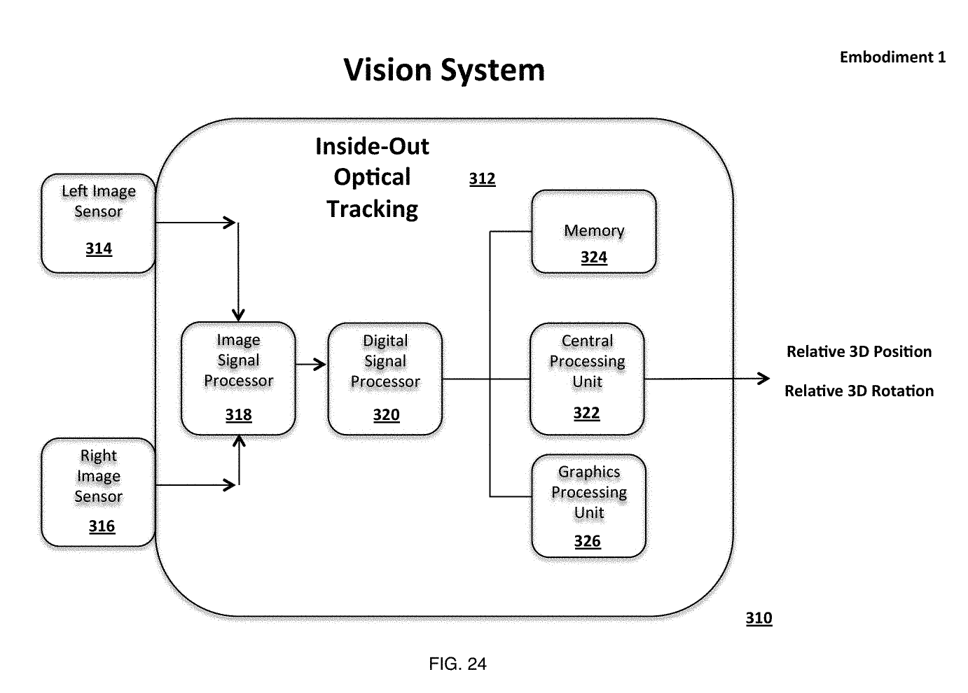

FIG. 24 is a functional block diagram of a vision system according to one embodiment of the disclosure. Referring to FIG. 24, a vision system 310 is a camera based system that produces relative location information that is relative to an initial position of the vision system 300. In one embodiment, vision system 310 may comprise a stereo-scopic vision system that includes a plurality of cameras (e.g., a charge-coupled device (CCD) type image detection camera) that allows for calculation of a pixel depth using triangulation techniques or calculations. Generally, the plurality of image detection devices may include one or more types of image detection devices such as infrared, traditional image capture (such as a CCD camera), distance measuring technologies such as laser and radar to assist with depth detection of the image pixels, etc. More specifically, the types of cameras and devices that may be used to produce relative location information include infrared cameras, infrared laser projectors, color cameras (CCD or CMOS technology), structured light cameras, time of flight (TOF) cameras and other camera types and devices as the technology develops.

More particularly, vision system 310 comprises a stereoscopic vision system configured to perform inside-out optical tracking according to one embodiment of the disclosure. Vision system 310 includes inside-out tracking device 312 that is coupled to receive image information from a left image sensor 314 and a right image sensor 316. The received image information from sensors 314 and 316 are produced to an image sensor processor (ISP) 318 that is configured to produce image-adjusted information to a digital signal processor (DSP) 320. More specifically, ISP 318 adjusts image characteristics such as intensity, color, etc. of the image information. DSP 320 receives the adjusted image data and performs more complex processing of the image-adjusted information such as filtering, and other mathematical manipulation of an image information signal (such as Fourier Transform filtering). The DSP 320 may also, in addition to any known mathematical filtering technique, measure or compress the image-adjusted information to produce digitally processed image information to at least one of a central processing unit (CPU) 322 or a graphical processing unit (GPU) 326.

GPU 326 includes, in the described embodiment, a plurality of processors configured to perform graphical processing of the digitally processed image information. Such graphical processing includes high level processing that may be computationally intensive such as detecting features such edges, lines, contrasting elements, etc. Furthermore, such graphical processing may include comparing detected features to previously detected features. The CPU 322 communicates with memory 324 to store data therein, to retrieve data therefrom, and to retrieve computer instructions that define the operational functions to be performed by CPU 322. In one embodiment, GPU 326 includes its operational logic in any form including hardware logic. In another embodiment, the one or more processors of GPU 326 retrieve computer instructions and/or image data from memory 324 to perform its operations. Depending upon logic distribution of CPU 322 and GPU 326, the detected features are analyzed to determine the relative 3D position information.

Generally, vision system 310 utilizes the image data from each of the image sensors 314 and 316 to calculate a pixel depth or distance relative to an origin using triangulation techniques and by comparing to prior detected features or keypoints to produce the relative 3D position information that includes 3D orientation information. The vision system 310 of the described embodiment is a depth camera that includes dual stereoscopic image sensors and operates to produce both raw images and depth values for each pixel.

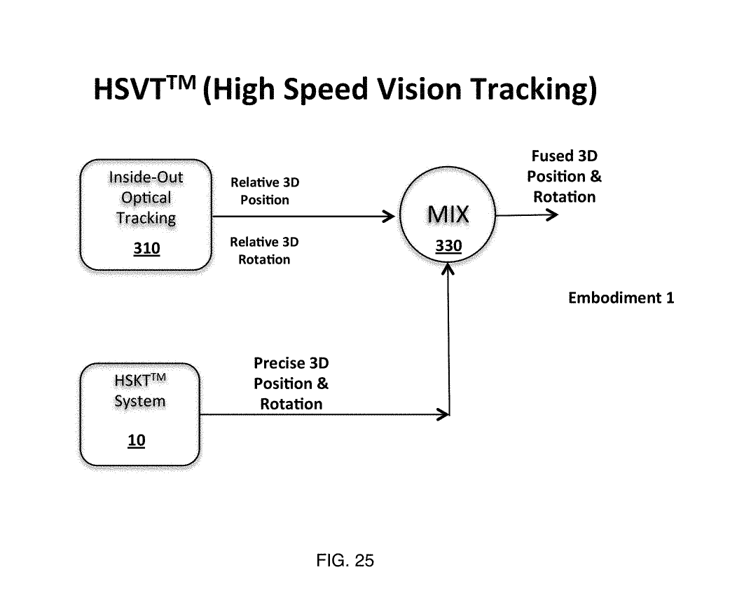

FIG. 25 is a functional block diagram that illustrates one aspect of operation of an HSVT™ system according to one embodiment of the disclosure. Referring to FIG. 25, it may be seen that a mixer 330 is coupled to receive relative 3D information (including 3D rotation information) from an inside-out optical tracking system 310 as well as precise 3D position and rotation information from an HSKT™ system 10. Mixer 330 then is configured to produce the fused 3D position and rotation information.

In one embodiment, the HSVT™ system operates to, upon startup, initialize a current location with the precise location and rotation information produced by HSKT™ 10. This process is defined by the following example steps/logic:

If(startup):

(10) Off.pos.x=HSKT.pos.x−Optical.pos.x;
Off.pos.y=HSKT.pos.y−Optical.pos.y;
Off.pos.z=HSKT.pos.z−Optical.pos.z;
Off.ang.x=HSKT.ang.x−Optical.ang.x;
Off.ang.y=HSKT.ang.y−Optical.ang.y;
Off.ang.z=HSKT.ang.z−Optical.ang.z;

where pos=3D position

ang=Euler angle (note that angles are normally stored and used as quaternions, but are converted to Euler for this calculation)

Off=Offset between precise HSKT™ coordinates and relative optical coordinates received from a camera or other vision device.

Generally, optical tracking is very precise from instant to instant, but drifts over time due to accumulation of small errors in the relative tracking accumulating over time. HSKT™ coordinates are absolute with no drift, but they can be less precise from instant to instant. The mixing block produces fused 3D position and rotation information which has sub-millimeter precision and has no drift. The optical tracking can completely fail from time to time depending on various factors such as lighting changes, low contrast in room and fast movements. When the optical tracking fails, the HSKT™ coordinates are used entirely. As such, without error, the fused coordinates are more accurate than the optical coordinates (because the drift error is eliminated) and more accurate that the precise location information because of the accuracy of the measurement of detected location changes produced by the optical camera systems.

It should be noted that, in one embodiment, the HSVT™ system includes logic for dynamically weighting the optical and precise location information based on error conditions. In one particular embodiment, deep learning and other AI techniques may be used for dynamically adjusting the weighting of the location information of either type to produce more accurate fused location information. Sometimes, for example, optical data may be erroneous because of conditions that cause the optical tracking to fail (such as viewing an image with an insufficient number of detectable keypoints). The precise location information from an HSKT™ system mail develop greater error tolerances due to multipath fading or interference. As such, the HSVT™ system is configured to adjust the fusing to account for detected anomalies.

Generally, the HSVT™ system, and more particularly, the mixer 330, performs the following calculations to update the fused position information:

(20) f.pos.x=Optical.pos.x+Off.pos.x;
f.pos.y=Optical.pos.y+Off.pos.y;
f.pos.z=Optical.pos.z+Off.pos.z;
f.ang.x=Optical.ang.x+Off.ang.x;
f.ang.y=Optical.ang.y+Off.ang.y;
f.ang.z=Optical.ang.z+Off.ang.z;

The offset positions are thus calculated as follows:

(30) Off.pos.x+=MIX_POS_X*(HSKT.pos.x−f.pos.x);
Off.pos.y+=MIX_POS_Y*(HSKT.pos.y−f.pos.y);
Off.pos.z+=MIX_POS_Z*(HSKT.pos.z−f.pos.z);
Off.ang.x+=MIX_ANG_X*(HSKT.ang.x−f.ang.x);
Off.ang.y+=MIX_ANG_Y*(HSKT.ang.y−f.ang.y);
Off.ang.z+=MIX_ANG_Z*(HSKT.ang.z−f.ang.z);

For normal operations where the optical tracking is working properly a constant of 0.05 is used as an example value for the Mix Position multiplier (MIX_POS_n). This constant can be dynamically adjusted based on the confidence of the optical tracking versus the HSKT™ precise location information tracking. Thus, if the optical tracking information is believed to be accurate:

(40) MIX_POS_X=0.05;
MIX_POS_Y=0.05;
MIX_POS_Z=0.05;
MIX_ANG_X=0.05;
MIX_ANG_Y=0.05;
MIX_ANG_X=0.05;

Otherwise, if the optical tracking information is not believed to be true,

(50) MIX_POS_X=1.0;
MIX_POS_Y=1.0;
MIX_POS_Z=1.0;
MIX_ANG_X=1.0;
MIX_ANG_Y=1.0;
MIX_ANG_X=1.0;

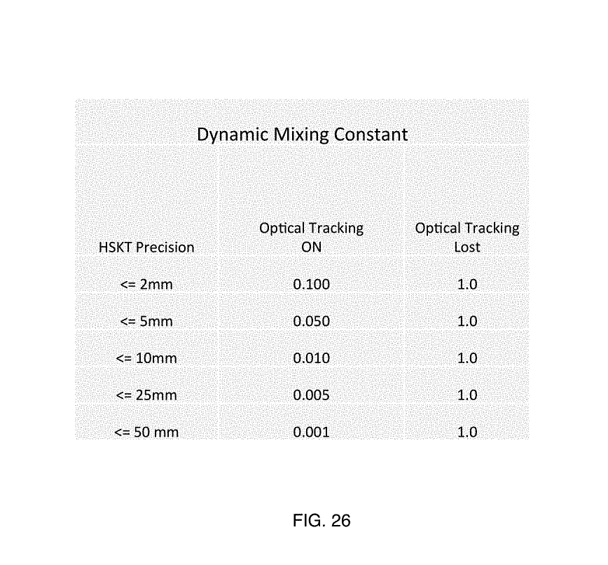

In an alternative embodiment, logic (e.g., artificial intelligence (AI) logic may be used to adjust the relative weighting of the optical and/or precise location information based on suspected error conditions. If an AI learning approach is not utilized, then another logical approach may be utilized such as that illustrated in relation to FIG. 26 below.

FIG. 26 is a table that illustrates use of a dynamic mixing constant (MIX_POS_n) based on operational conditions. In all cases, if optical tracking is lost, the dynamic mixing constant is set=1.0. If optical tracking is not lost, however, the dynamic mixing constant varies with the precision of the HSKT™ tag/processor 10 absolute location information. As may be seen from examining the table, as the HSKT™ precision varies from 2 mm to less than 50 mm, the dynamic mixing constant ranges from 0.100 to 0.001 (thereby reducing the affect of the HSKT™ processor output upon the final answer of the fused location information.

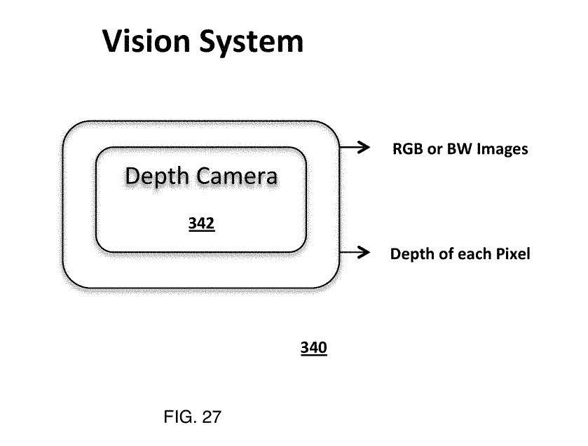

FIG. 27 is a functional block diagram of a vision system according to one embodiment of the invention. Referring to FIG. 27, a functional block diagram of one embodiment of a vision system 340 and, more particularly, of a depth camera 342 is shown. The vision system 340 comprises a depth camera 342 that comprises a dual stereoscopic imager that outputs both raw images and depth values for each pixel of the raw images. As such, image data and depth data from one image may be compared to another image, e.g., by the HSVT™, to determine accurate relative movement. The HSVT™, by fusing such movement information with absolute location information from the HSKT™, is operable to provide very accurate location information.

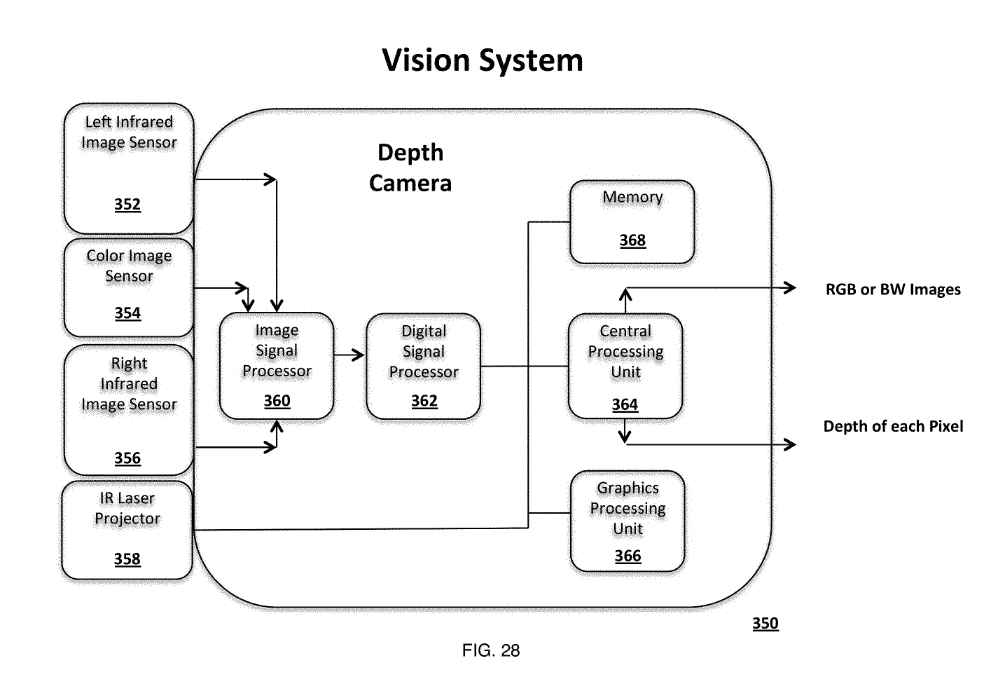

FIG. 28 is a functional block diagram of a vision based location tracking system according to one embodiment. Referring to FIG. 28, the vision based system 350 shown may, in one embodiment, represent vision system 340 in greater detail. Vision system 350 includes a left infrared image sensor 352 that generates image data based on infrared image data, a color image sensor 354 that identifies colors for detected pixels, a right infrared image sensor 356 that also generates image data based on infrared image data. Each of the sensors 352-356 produce image data as described to an image signal processor 360 that analyzes the received data to correlate the image data from the sensors 352-356 to digital signal processor 360. Digital signal processor 360 then processes the data to filter, amplify and process the image data to produce image information to central processing unit 364. An infrared laser projector 358 projector produces texture data for a detected image at the pixel level to a graphics processing unit 366. Graphics processing unit 366 generates distance information based on the texture data for the detected image to central processing unit 364. Central processing unit 364 then correlates the distance information with the image information received from the digital signal processor 360 to produce images (RGB or black and white) as well as depth information on the pixel level for each pixel of the produced images. Central processing unit 364 further communicates with memory 368 to store image data and other data as well as to retrieve computer instructions that define the algorithms and operation of central processing unit 364.

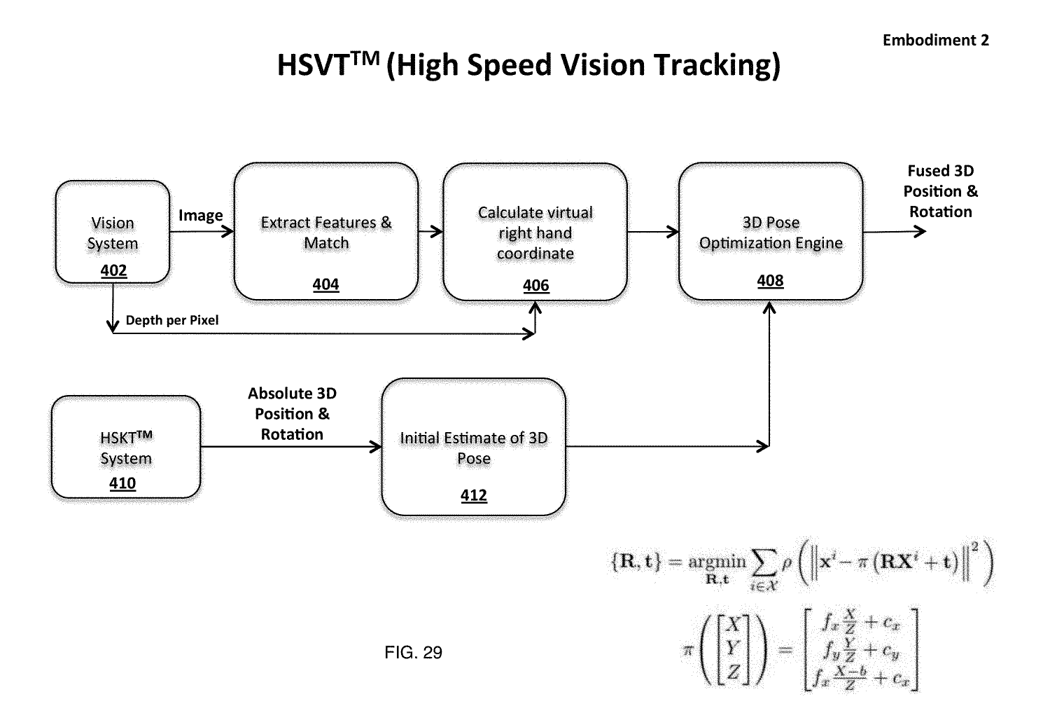

FIG. 29 is a functional block diagram of a high speed vision tracking system that fuses relative location information with absolute location information according to one embodiment.

As may be seen, a vision system such as vision based system 350 or 340 of FIGS. 27-28 produces image information for subsequent processing. The camera outputs individual frames of RGB image data in the described embodiment that is time stamped along with depth information from each pixel. The time stamp may be used, for example, to assist with key point determination and image correlation. An extraction block operates to receive the image data and to extract features in the image data and to match the extracted features to the same features in one or more previous images. To accomplish this, the extraction block identifies various features in the image. More specifically, ORB (Oriented FAST and Rotated Brief) features are located in the current frame and matched to the previous frame. These features are detectable using known ORB feature detection algorithms. Each feature has corresponding keypoints (u,v) in the image plane. The keypoints (u,v) are then produced to a coordinate calculation block that calculates virtual right hand coordinates for the keypoints. More specifically, the coordinate calculation block calculates a virtual right hand coordinate (r) from r=u−fx*b/d. Where u is from the previous block, fx is the horizontal focal length and b is the baseline between the structured light projector and the camera. The full keypoint (u,v,r) can now be determined with the determination of r. It should be noted that the coordinate calculation block 406 also receives the pixel depth information from vision system 402 as a part of determining the right hand coordinate system data.

Absolute 3D position and rotation data is output from the HSKT™ system 410. In the described embodiment, the absolute 3D position and rotation data is as described previously and is produced from HSKT™ system 410 to estimator 412 that produces an initial estimate of a 3D position. The position and rotation data from the HSKT™ system becomes the initial estimate for a 3D pose optimization engine of estimator 412. One aspect of this step is that this step reduces the total processing time by 99.6% compared to a visual SLAM based solution. In a typical visual SLAM based system, tracking requires 25 ms, mapping requires 250 ms, loop closing requires 600 ms and relocalization requires 1800 ms. This requires a lot of processing power. With this embodiment, all of these steps is removed except for the tracking which now only requires 10 ms total.

### 3D Pose Optimization Engine

The initial estimate of position and rotation is produced by estimator 412 to a 3D optimization engine 408 that is then optimized by minimizing the reprojection error between matched 3D coordinates and the matched feature keypoints (u,v,r) using the Levenberg-Marquardt method. Using the following definitions, the position may be optimized using the formula cited below in (1):

R—Rotation to be optimized.

t—Translation to be optimized.

p—Huber cost function

x—Matched feature keypoints (u,v,r)

X—Matched 3D coordinates (x,y,z)

fx,fy—Camera focal length.

cx,cy—Camera principle point.

b—Baseline between infrared projector and camera.

$$\{ R , t \} = {argmin}_{R , t} {\sum }_{i ∈ χ} ρ ( {‖ {x}^{i} - π ( {RX}^{i} + t ) ‖}^{2} ) \\ π ( [ \begin{matrix}X \\ Y \\ Z\end{matrix} ] ) = [ \begin{matrix}{f}_{x} \frac{X}{Z} + {c}_{x} \\ {f}_{y} \frac{Y}{Z} + {c}_{y} \\ {f}_{x} \frac{X - b}{Z} + {c}_{x}\end{matrix} ] \qquad ( 1 )$$

One aspect of the disclosure is that a fusion of vision and wireless tracking systems is utilized to produce a tracking system with sub millimeter accuracy and that does not lose location due to drift and that is capable of generating precise location updates at a rate of 60 updates per second or more. Upon startup, the vision tracking system does not know its absolute 3D location. It can, however, track its location that is relative a starting point with sub millimeter precision. Over time, however, errors cumulate and the vision system's absolute 3D location drifts as total error increases and needs to be corrected. Moreover, there often exists a need to know accurate actual location information in addition to the precise relative location information. Therefore, the HSKT™ wireless tracking system constantly corrects the drift by providing accurate absolute location information that is fused with the very precise relative location information in the vision tracking system. The HSKT™ system generates three dimensional absolute location information upon startup as well as with frequent updates. By fusing these two tracking technologies together, sub millimeter precision and accurate absolute 3D location may be realized and maintained at a rate of 60 updates per second or faster. Additionally, it should be understood that in alternative embodiments, the accurate relative location information of the vision system may be fused with other location information such as GPS location information. In such alternative embodiments, the “absolute” location information is not as precise as that provided by the HSKT™ system, but may be satisfactory accurate so long as the precise relative location information is fused with the less accurate “absolute” location information. For example, in a network of automobiles traveling down a highway, the “absolute” location information may be fused with the precise relative location information produced by a vision system to obtain location information that is used for driving purposes and especially for collision avoidance. In such a system, the “absolute” location information may be provided by an HSKT™ system when available and by a GPS system when the HSKT™ system is not available or is otherwise preferable.

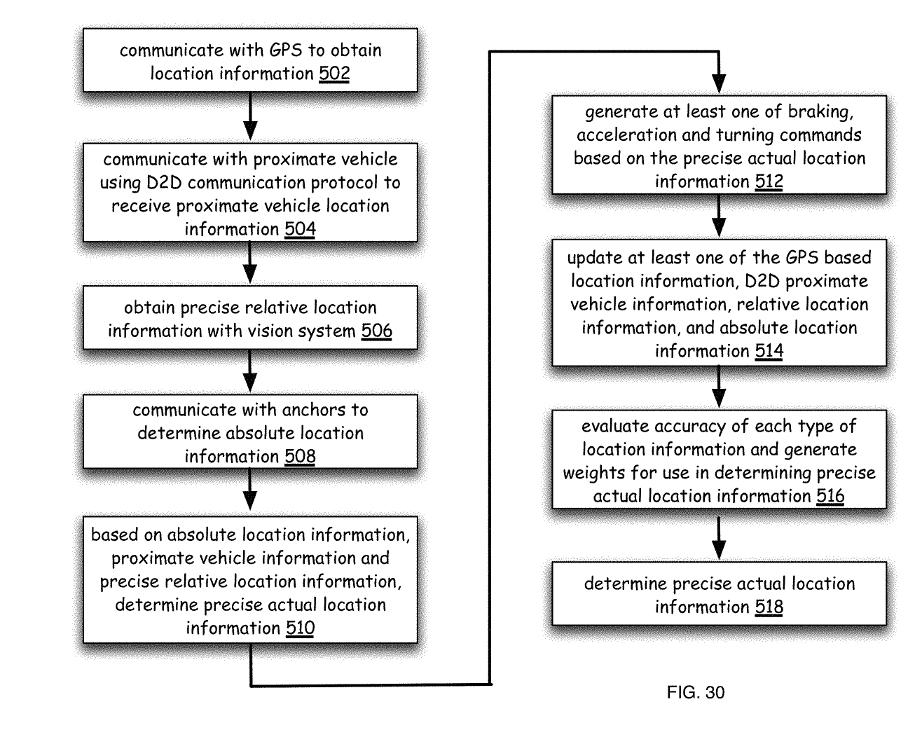

FIG. 30 is a flow chart illustrating one embodiment of the present disclosure performed by a location determination system that is part of an automobile. Such a location determination system may include any of the previously described aspects and, generally, operates to determine accurate location information. In this specific embodiment, a location determination system being used within an automobile is described. The method begins with the system communicating with GPS transceivers (satellites or satellite relays) to obtain location information (502). Typically, such location information is with a first degree of accuracy (e.g., a meter or two). communicate with proximate vehicle using D2D communication protocol to send and/or receive proximate vehicle location information (504). The system also receives location information from a camera based vision system to obtain precise relative location information (506). While it is necessary to use received location information from another vehicle as well as from GPS transceivers, it is also necessary to obtain relative location information from a camera or vision system. For example, a known fixture having a known coordinate may be used to determine a relative location and even a precise actual location. Alternatively, which distances may be calculated between two vehicles using the aforementioned received location information, actual relative differences between two vehicles is important data to determine precise location information to avoid an accident.

One issue, however, is that the system cannot receive GPS information from the GPS transceivers when there is sufficient occlusion or signal path losses such as may happen, for example, in a tunnel. Accordingly, one aspect of the present method is that the system communicates with anchors to determine absolute location information (508). Such communications occur whenever anchors are present and an adequate number of anchors are in communication with the system to provide absolute location information (such as described previously in relation to the discussions of the HSKT™ systems). Thereafter, based on absolute location information, proximate vehicle information and precise relative location information, the system determines precise actual location information (510).

Based on this precise actual location information, as well as other factors, the automobile which includes the system is configured to generate at least one of braking, acceleration and turning commands based on the precise actual location information (512). Thereafter, the system is configured to update at least one of the GPS based location information, D2D proximate vehicle information, relative location information, and absolute location information (514). In one embodiment, the system is configured to evaluate accuracy of each type of location information and generate weights for use in determining precise actual location information (516) and, based on those determinations about the accuracy of each type of location information, to determine precise actual location information (518).

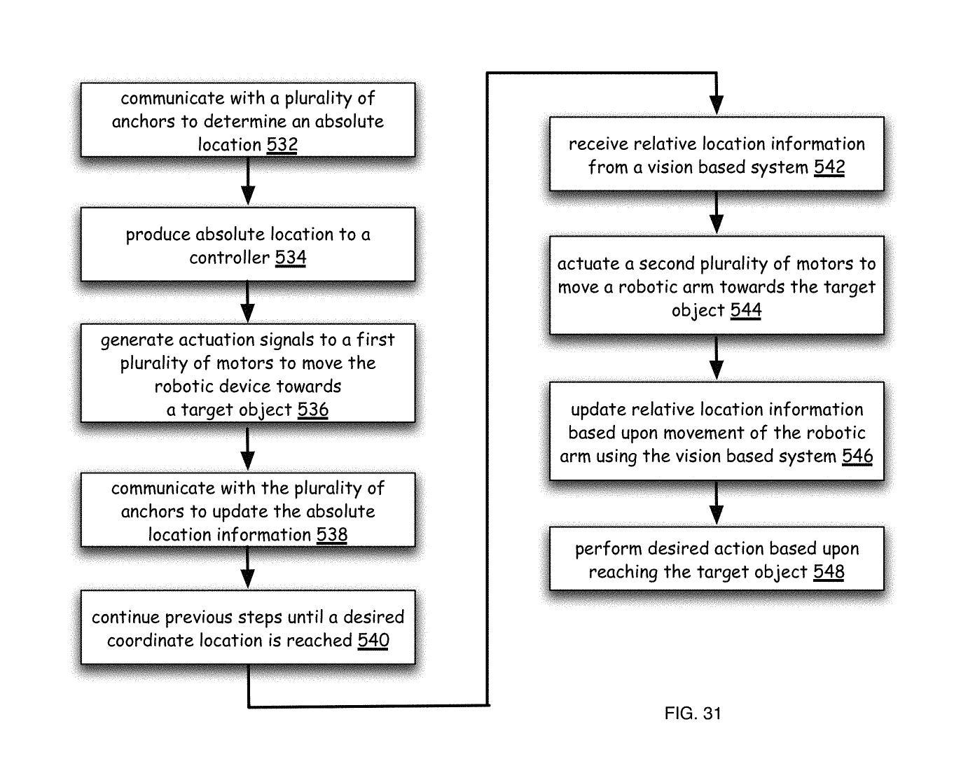

FIG. 31 is a flow chart illustrating a method of a robotic device that includes a location determination system according to one embodiment of the disclosure. The method commences with the location determination system communicating with a plurality of anchors to determine an absolute location (532). This method may be, for example, that described previously for the HSKT™ devices. Accordingly, the location determination system produces absolute location information to a controller of the robotic device (534). Based on the received absolute location information, the controller generates actuation signals to a first plurality of motors to move the robotic device towards a target object (536). The location determination system continues to communicate with the plurality of anchors to update the absolute location information to produce updated location information to the controller (538). The previous steps are continued by the robotic device until a desired coordinate location is reached (540). Thereafter, the robotic device is configured to and receives relative location information from a vision based system (542). Based on at least one of the absolute and relative location information, the controller of the robotic device actuates a second plurality of motors to move a robotic arm towards the target object (544). Thereafter, the robotic device (and more specifically, the location determination system) updates relative location information based upon movement of the robotic arm using the vision based system (546). This process continues until the robotic arm reaches the target object. Thereafter, the controller actuates control signals to perform a desired action based upon reaching the target object 548.

One aspect of the aforementioned embodiment is that the HSKT™ (absolute location determination system) is used to actuate a first set of motors while a vision based system is used to actuate a second set of motors. The first set of motors may be, for example, motors that drive the robotic device to a location. The second set of motors may be those associated with movement of one or more arms, fingers and rotational elements that are configured to enable the robotic device to perform a task. While the described embodiment illustrates sequential operation, it should be understood that the use of the two location determination systems and associated motor actuations may overlap (occur at the same time) or they may be sequential as described.

The previous two figures and methods are to illustrate the many alternative embodiments and methods of devices that utilize both an absolute location determination system (such as the HSKT™ system) and a vision based system. Many other applications may include implementations of one or both of these systems as well as other systems. These applications include:

### Virtual Reality

In virtual reality (VR), the user wears a head mounted device (HMD) that completely replaces the user's real environment with a computer-generated display that shows the virtual experience. This experience can be for gaming, training, education, long distance collaboration, virtual shopping, or to allow the user to view real estate properties without actually visiting them in person. The key to making the VR experience feel as real life is to be able to accurately update the user's orientation (rotation) and 3D location at high update rates in a large space where the user is free to walk, run, jump, or move in any direction at any point. Location based VR has larger spaces that allows for multiple users to share the same experience at the same time. The accurate 3D location is required to prevent users from running into physical walls or prevent multiple users from running into each other. The accurate 3D location also allows more intricate experiences where physical props are lined up with the virtual environment that will allow the user to reach out and feel physical things that line up exactly with their virtual experience. In this application, the cumulative effects of drift could cause players to run into each other or into objects. Moreover, in an environment that has physical objects to supplement the virtual reality, it is important for the images to be accurate in relation to location so that such physical objects (e.g., door knobs) are located where the virtual reality imagery shows them to be.

### Augmented Reality

In augmented reality (AR), the user sees the real environment, but it is augmented with computer generated objects or information. For example, the user can look at a table that has nothing on it in the real environment, but by looking through an HMD, tablet, or phone the user sees virtual objects that appear to be on the table and can be interacted with. The key to making the augmented objects feel life like is to be able to accurately place the objects on the real environment with no drift. This requires the HMD, tablet, or phone to have an accurate orientation (rotation) and 3D location at high update rates. The real environment may involve very large spaces such as an entire aircraft carrier. This would allow augmented objects, or information to be overlaid on top of real things. For example, a user can be presented with an exploded view of an engine and give information related to the repair in real time. The accurate 3D location is required to properly line up the augmented objects with the things in the real environment. In this application, the cumulative effects of drift could cause players to run into each other or into objects. Moreover, in an environment that has physical objects to supplement the virtual reality, it is important for the images to be accurate in relation to location so that such physical objects (e.g., door knobs) are located where the virtual reality imagery shows them to be. Moreover, because augmented reality includes virtual imagery as well as actual images, it is important of the virtual imagery to be placed correctly in relation to the actual imagery. Having precise location information facilitates such results.

### Autonomous Cars and Drones

With autonomous cars and drones they are given the ability to sense their environment and navigate with no human input. For example, an autonomous car would have the ability to transport people from place to place with no human driver. The key to making the technology work is to always have an accurate 3D position that is updated at a high rate. One big problem occurs in GPS denied areas such as under a bridge, inside a parking structure, or any indoor location. Therefore, another tracking technology needs to be used. For example, as the car enters a parking structure, the embodiments of this disclosure can guide the car to the correct parking spot. Consider parking, for example. The more precise the location information the closer a vehicle can be allowed to come within another object. In another example, a caravan of self-driving cars can follow each other very closely by monitoring the distance between each car using the HSKT™ wireless tracking technology in addition to other technologies such as communication technologies in which the vehicles exchange precise location information, vector information (including acceleration information.

### Autonomous Robots

With the development of autonomous robots having the ability to sense the environment and to navigate with no human input. For example, an autonomous robot would have the ability to accurately find a location within the factory within millimeters in terms of absolute location. That allows the robot could inspect a particular part using vision or even to guide the robot's hand with sub millimeter accuracy to enable the robot to precisely pickup a specific part off of a storage location or off a conveyor. Having an accurate 3D position that is updated at a high rate facilitates such robotic operations.

### Light and Camera Tracking

With light and camera tracking, the accurate orientation (rotation) and 3D location of the light, the camera, or of the subject that the light or camera is focused on. For example, knowing the 3D location of the light and getting high speed updates of the subject's 3D location, the light can be automatically oriented so that the subject is always lit properly. This process would require no human input. In another example, adding the precise orientation (rotation) and 3D location of the camera to each frame would allow for special effects and 3D objects to be added to the post film production that were not originally there.

### Indoor Laser Tag and Other Gaming Systems

Laser tag systems and other similar gaming systems are similar to the VR systems described above wherein the imagery is displayed in relation to the precise location information of the user as well as the precise location information of the other users. Interestingly, individuals playing laser tag would not be required to be collocated because data transmitted over the Internet could be merged with a VR gaming system to virtually place the users proximate to each other for the game whether the game is laser tag or other game (e.g., racing game, fighting game, etc.). As before the technology may comprise dedicated hardware as described herein, a processor and software based system, or a combination of the two.

### Motion Capture

Having precise location information may also be used to capture motion for many applications including remote coaching, gaming, simulated group activities, etc.

### Speaker and Equipment Tracking

Precise location and position information may be used to accurately determine a speaker for purposes of identification, for example, in a large group of people and/or for filming purposes for aiming and zoom calculations for a camera. More generally, precise location and position information may be used within an organization to quickly locate a specific person (e.g., a doctor, nurse or surgeon) or a piece of equipment (a specialized device that is in short supply for any reason including cost).

### Fitness Tracking

Fitness trackers are known, but the accuracy of the results are sometimes suspect because of a lack of precise location and position information, especially when indoors. Moreover, accurate motion tracking allows for more precise energy consumption calculations (e.g., calories consumed).

### Military and Defense

Precise location and position information may be used in countless applications including training, weapons delivery, targeting etc. For example, helmet mounted sight systems, with precise location and position information may be used to slew radar systems and other targeting systems to the precise point that a user or pilot is identifying by the orientation of his helmet. Accordingly, a pilot may more quickly designate a target to release ordnance and subsequently retreat to minimize risk of being shot by enemy systems. Such targeting systems may be for major weapons systems (tanks, ships, bombers and fighter airplanes) as well as personalized weapons systems. In one embodiment, a precise location and position determination system is used with a mobile weapons system that, in one embodiment, may be carried or worn by an individual. Position determination systems may also be used for tracking for teaching purposes (e.g., tracking movement for weapons training, etc.).

### High Speed Industrial Machinery

Precise location information may be determined in scenarios in which tracking rotation or position in an environment where wires cannot be used or are preferably not used. One or more of the HSKT, HSVAIT and HSVT devices/systems/technologies may be used in a manner similar to what has been described herein for the specific application for industrial machinery.

While the invention is susceptible to various modifications and alternative forms, specific embodiments thereof have been shown by way of example in the drawings and detailed description. It should be understood, however, that the drawings and detailed description thereto are not intended to limit the invention to the particular form disclosed, but, on the contrary, the invention is to cover all modifications, equivalents and alternatives falling within the spirit and scope of the present invention as defined by the claims. As may be seen, the described embodiments may be modified in many different ways without departing from the scope or teachings of the invention. The present disclosure, for example, describes an HSKT™ system that produces absolute location information. This HSKT™ system may readily be combined with vision tracking system such as the HSAIT™ and HSVT™ systems described herein.

What is claimed is:

1. A method performed by a location determination, comprising:
receiving, via an ultra-wide band communication transceiver, ultra-wide band RF signals containing locations of each of at least three anchors and determining an X coordinate, a Y coordinate and a Z coordinate based on the received ultra-wide band RF signals;
determining a location estimate Kalman filtering, in a plurality of Kalman filters, X coordinate, Y coordinate and Z coordinate calculations to statistically determine a probable absolute location estimate;
receiving image data from a camera system and extracting relative position information in relation to prior image data; and
evaluating the absolute location estimate as well as the relative position information to determine precise location information.

2. The method of claim 1, further comprising:
determining, via a processor, ranging information of each of at least three anchors by transmitting and receiving ultra-wideband communication messages via the ultra-wide band device and determining an associated transmission time of flight between the tag/processor device and the at least three anchors;
determining a distance between the tag/processor device and the at least three anchors from the determined ranging information;
determining an altitude of the tag/processor device based on temperature and pressure data; and
determining an absolute tag/processor device location estimate based on the locations and ranging information of the at least three anchors.

3. The method of claim 1 wherein the step of determining the precise location information includes the step of determining the precise location information based on both the absolute location estimate as well as the relative position information.

4. The method of claim 1 wherein the step of determining the precise location information includes the step of determining the precise location information by applying weights to at least one of the absolute location estimate and the relative position information.

5. The method of claim 1 further including actuating a first set of motors based on one of the one of the absolute location estimate and the relative position information and actuating a second set of motors based on another of the absolute location estimate and the relative position information.

6. The method of claim 1 wherein at least one of a GPS system and an HSKT™ system is used to provide the absolute location information.

7. An apparatus in a location determination system, comprising:
an ultra-wideband radio that produces ingoing digital communication signals from received ultra-wideband radio frequency signals;
a processor coupled to receive ingoing digital communication signals from the ultra-wideband radio;
a memory comprising computer instructions coupled to the processor that, when executed by the processors, causes the processor to perform the steps of:
receiving the ingoing digital communication signals from the ultra-wideband radio containing location information from each of a plurality in the location determination system to determine absolute location information;
receiving image data from a camera system and extracting relative position information in relation to prior image data; and
evaluating the absolute location estimate as well as the relative position information to determine precise location information.

8. The apparatus of claim 7 wherein the processor performs the step of determining ranging information of each of the plurality of other apparatuses by:
generating and producing outgoing digital transmission signals device and receiving responsive ingoing digital communication signals ultra-wideband communication messages and determining associated transmission time of flight between the apparatus and the plurality of other apparatuses;
determining a distance between the apparatus and the plurality of other apparatuses from the determined ranging information; and
determining an apparatus location estimate based on the locations and ranging information of the plurality of other apparatuses.

9. The apparatus of claim 8 wherein the processor performs the step of determining a location estimate by Kalman filtering, in a first plurality of Kalman filters, X coordinate, Y coordinate and Z coordinate calculations to statistically determine a probable location having a first degree of resolution.

10. The apparatus of claim 7 wherein the processor determines the precise location information based on both the absolute location estimate as well as the relative position information.

11. The apparatus of claim 7 wherein the processor determines the precise location information by applying weights to at least one of the absolute location estimate and the relative position information.

12. The apparatus of claim 7 wherein the processor actuates a first set of motors based on one of the one of the absolute location estimate and the relative position information and actuates a second set of motors based on another of the absolute location estimate and the relative position information.

13. The method of claim 1 wherein at least one of a GPS system and an HSKT™ system is used to provide the absolute location information.

14. A method for determining precise location information, comprising:
receive image data from a vision system;
using a first deep convolutional neural network, extract 2D or 3D points from each image in the image data;
generate relative position and orientation changes from the received image data in relation to prior received image data;
receive absolute position and orientation data from an absolute location determination system along with statistics or signal quality metrics the provide information about the quality of the wireless signals;
using a second deep neural network, recognize patterns in the absolute position and orientation data to determine when the data should be trusted and used; and
using a third deep neural network, combine the relative position/orientation of the camera(s) with the accurate absolute position/orientation data of the absolute position and orientation data to correct errors due to long term drift in the relative data and correct short term errors and anomalies in the absolute position and orientation data.
